(19) United States
(12) Patent Application Publication
(10) Pub. No.: US 2026/0116430 A1
(43) Pub. Date: Apr. 30, 2026

(54) OPERATIONAL DESIGN DOMAIN FOR MANEUVERING AND NAVIGATION

(71) Applicant: Pony.ai, Inc., Fremont, CA (US)

(72) Inventors: Zhen Wu, San Jose, CA (US); Andreas Reschka, Foster City, CA (US)

(21) Appl. No.: 18/930,300

(22) Filed: Oct. 29, 2024

(51) Int. Cl. B60W 60/00; B60W 50/02; H04L 67/12

(52) U.S. Cl. CPC B60W 60/0015; B60W 50/0225; H04L 67/12

(57) ABSTRACT

A system includes one or more processors that obtain sensor data; characterize the sensor data, obtaining one or more analysis results from the characterized sensor data, validate the one or more analysis results based on feedback data, based on the one or more analysis results and the validation thereof, create an operational design domain, and generate an operational protocol based on the operational design domain. The generating of the operational protocol includes translating the operational design domain into executable commands directed to an ego vehicle.

### BACKGROUND

The meteoric rise in deployment of autonomous or semi-autonomous vehicles has been a catalyst that has ushered in a new era of mobility. Ensuring the safety, efficiency, and reliability of these vehicles is a paramount priority. By 2040, an anticipated 75 percent of vehicles will be autonomous or semi-autonomous, according to the Institute of Electrical and Electronics Engineers (IEEE).

### SUMMARY

An Operational Design Domain (ODD) is created and updated to provide operating criteria for autonomous or semi-autonomous vehicles (hereinafter “autonomous vehicles” or “AVs”). The ODD indicates an extent to which AVs are operable (e.g., an operational extent) under different conditional constraints or scenarios. Conditional constraints may encompass geographic location, types of roadways, traffic conditions such as traffic density, distribution and speed, environmental conditions, temporal restrictions, and other features that affect navigation of an AV. The ODD provides safety assurance by characterizing metes and bounds of operation of an AV (e.g., an operational environment) which ensures that the AV is capable of reliably, safely, and efficiently handling navigation and maneuvering tasks. The ODD is also instrumental for legal and regulatory compliance and certification. ODD creation and evolution are documented and logged as evidence of AV deployment and testing. Additionally, the ODD instills trust and confidence in users, such as drivers and passengers, by delineating clear boundaries of operation.

The ODD encompasses a gamut of different scenarios, including complex and/or rare scenarios. The ODD is comprehensive and flexible to address dynamic scenarios, including different or changing road conditions, environmental conditions (e.g., weather and visibility conditions), and traffic patterns. The ODD is scalable to cover different geographical regions, which have different features such as different driving customs, infrastructure, and/or terrain.

The ODD is created by comprehensively characterizing different scenarios, failures, accidents, and other unknown or unexpected behaviors. Precisely and granularly defining operational criteria within the ODD solves existing technical problems that are plaguing safety of AVs.

An existing technical problem that is plaguing AV safety includes an inability to effectively define operational extents of an AV. This problem stems from a reliance on human domain experts in current approaches that attempt to define operational extents of an AV. The reliance on human domain experts not only introduces human error and/or bias, but is also attributed to an inability to sufficiently adapt to evolving conditions. This inability is reflected in a failure to evolve with changing environments or technological advancements such as new vehicle features. The current approaches do not accurately reflect the unpredictability and multivariable nature of real-world conditions, and are expensive and time-consuming. These approaches fall short due to failure to incorporate comprehensive, diverse data sets from actual vehicle operation. Other reasons current approaches fall short is difficulty in verifying and validating the ODD due to an absence of standardized, objective metrics, and a slow process of updating ODDs.

Embodiments of the present invention overcome these bottlenecks. Embodiments of the present invention implement a computing system that harnesses vast amounts of multi-modal sensor data from sensors such as cameras, Lidar, and radar across different characteristics and locations. This multi-modal sensor data is augmented with recorded behavioral data associated with an ego vehicle, other vehicles, and other environmental characteristics. The behavioral data includes speed and/or acceleration patterns of ego vehicles and agents under different recorded characteristics. Multifaceted analysis techniques are implemented including statistical analysis, clustering, and pattern recognition to understand common and edge scenarios. Classical and machine learning algorithms for deterministic analysis are applied when appropriate. The computing system defines the metes and bounds of an ODD while engaging in a feedback loop in which the ODD is regularly updated based on new data. In some embodiments, the ODD may include or be reflected as one or more datasets. As new data becomes available, the computing system may continuously update and refine the ODD. In particular, as new accident and/or sensor data becomes available, operational extents of AVs may be more granularly defined under certain conditional constraints. For example, new data regarding operation of AVs in certain off-road terrains may be used to update the ODD, specifically, to define operational extents under conditional constraints of off-road terrains. The computing system may translate the ODD into executable commands as part of a safety model and implement the executable commands. In some embodiments, under certain conditional constraints, the computing system may activate or inactivate certain vehicle features, such as advanced driver-assistance systems (ADAS) or lane change assist (LCA). In some embodiments, under certain conditional constraints, the computing system may enforce certain driving limitations such as prohibiting turns of less than a given curvature and/or instituting speed limitations. The computing system may apply the definition of the ODD for different vehicles of a given type and/or may modify the definition of the ODD for different vehicles. The ODD is ensured to comply with regulatory guidelines, rules, and procedures.

By implementing the ODD described herein, probabilities of accidents are reduced by identifying and granularly analyzing potential hazards within different conditional constraints. An ego vehicle is able to anticipate and respond to previously unforeseen circumstances more effectively. An ego vehicle is able to proactively prepare for potential safety challenges to reduce probability of an accident, and/or mitigate a severity of an unavoidable accident.

In some embodiments, a computing system comprises one or more processors; and a memory storing instructions that, when executed by the one or more processors, cause the system to perform operations. The operations include obtaining sensor data; characterizing the sensor data; obtaining one or more analysis results from the characterized sensor data; validating the one or more analysis results based on feedback data (e.g., feedback and validation data); based on the one or more analysis results and the validation thereof, creating an operational design domain, wherein the operational design domain comprises a dataset specifying operational extents of an ego vehicle corresponding to different constraints (e.g., conditional constraints); and generating an operational protocol based on the operational design domain, wherein the generating of the operational protocol comprises translating the operational design domain into executable commands directed to the ego vehicle. In some embodiments, the operational protocol may override existing vehicle functionality. In some embodiments, the sensor data may include historical sensor data, and/or accident data.

In some embodiments, the obtaining of the sensor data is from different sensor modalities, the different sensor modalities comprising a Lidar, a camera, and a radar.

In some embodiments, the characterizing of the sensor data comprises fusing the obtained sensor data into a unified data collection, wherein the fusing of the obtained sensor data comprises normalizing different formats of the sensor data into a common format.

In some embodiments, the obtaining of the one or more analysis results is based on classical pattern recognition techniques and machine learning techniques; and the obtaining of the one or more analysis results comprises: identifying characteristics, from the characterized sensor data, that have an impact on one or more safety-related parameters; and inferring, from the characterized sensor data, a degree of impact of each characteristic on the one or more safety-related parameters. In some embodiments, characteristics may correspond to the aforementioned constraints. Characteristics may refer to the sensor data (e.g., actors such as vehicles within the sensor data) while constraints may refer to the ego vehicle. In some embodiments, safety-related parameters include interaction and speed-related parameters and vehicle component parameters.

In some embodiments, the operational extents indicate permitted actions and restrictions of the ego vehicle.

In some embodiments, the constraints comprise geographical conditions, traffic conditions, environmental conditions, temporal conditions, or infrastructure conditions.

In some embodiments, the instructions further cause the system to perform implementing the executable commands within components of the ego vehicle, the components comprising an actuator, brake, and/or steering wheel.

In some embodiments, the implementing of the executable commands comprises selectively limiting a force applied to the actuator or selectively limiting an amount of turning of the steering wheel.

In some embodiments, the instructions further cause the system to perform: based on the feedback data, training a machine learning component that performs part of the obtaining of the one or more analysis results.

In some embodiments, the instructions further cause the system to perform: in response to generating the operational protocol, monitoring one or more ego vehicle safety-related parameters when the ego vehicle is operating according to the operational protocol; and in response to detecting that one or more ego vehicle safety-related parameters fall outside of respective safety ranges, iteratively updating the operational design domain until the one or more ego vehicle safety-related parameters are within the respective safety ranges.

In some embodiments, an ego vehicle, as illustrated and described, for example, in FIGS. 15-16, may be implemented in conjunction with the computing system described above.

In some embodiments, a method of a computing system performs obtaining sensor data; characterizing the sensor data; obtaining one or more analysis results from the characterized sensor data; validating the one or more analysis results based on feedback data; based on the one or more analysis results and the validation thereof, creating an operational design domain, wherein the operational design domain comprises a dataset specifying operational extents of an ego vehicle corresponding to different constraints; and generating an operational protocol based on the operational design domain, wherein the generating of the operational protocol comprises translating the operational design domain into executable commands directed to the ego vehicle.

These and other features of the apparatuses, systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the invention are utilized, and the accompanying drawings of which:

FIG. 1 is a diagram that illustrates an example implementation of a computing system that creates an operational design domain (ODD).

FIG. 2 is a diagram that illustrates an example implementation of the computing system that creates an ODD in more detail.

FIG. 3 is a diagram that illustrates an example vehicle context related to creation of an ODD.

FIGS. 4-5 are diagrams that illustrate example implementations of pattern analysis.

FIGS. 6-7 are diagrams that illustrate creation of an ODD which defines operational extents of an ego vehicle under different conditional constraints, such as traffic conditions and environmental conditions, from characterized sensor data.

FIGS. 8-9 are diagrams that illustrate creation of an ODD which defines operational extents of an ego vehicle under different conditional constraints, from characterized sensor data. FIGS. 8-9 directly map conditional constraints to safety-related parameters of vehicle components.

FIGS. 10-11 are diagrams that illustrate creation of an ODD which defines operational extents of an ego vehicle under different conditional constraints, such as certain driving behavior conditions.

FIG. 12 is a diagram illustrating an example representation of an ODD.

FIG. 13 illustrates example implementations of training of machine learning components to infer patterns from characterized sensor data.

FIGS. 15-16 illustrate example ego vehicles in which the aforementioned implementations may be implemented.

FIG. 17 illustrates a block diagram of a computer system upon which any of the embodiments described herein may be implemented.

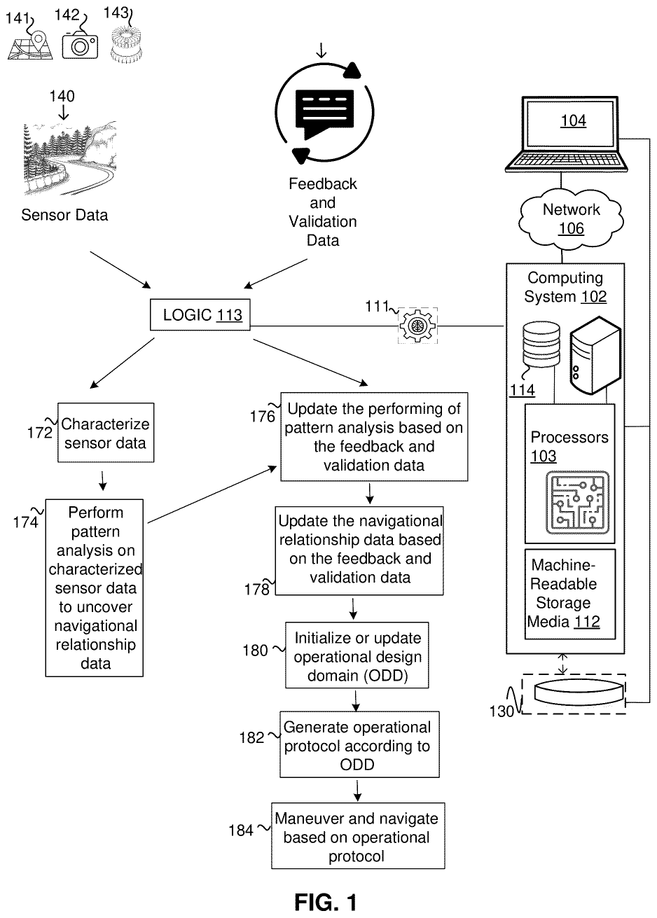

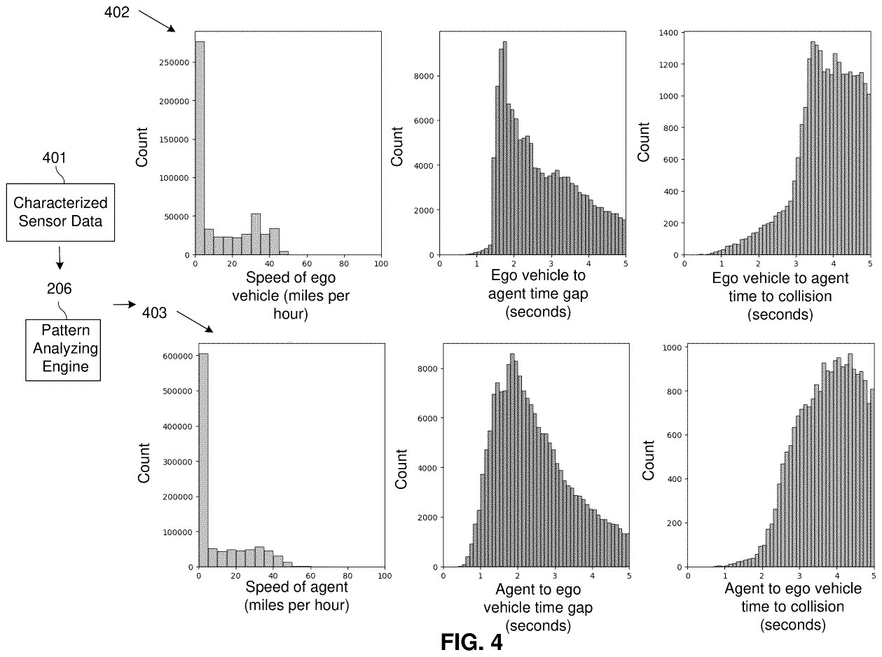

Principles from different figures may apply to, and/or be combined with other figures as suitable. For example, the principles illustrated in FIGS. 1-3 may be applied to and/or combined with principles from any of FIGS. 4-16, and vice versa.

### DETAILED DESCRIPTION

Safety of vehicles, such as autonomous and semi-autonomous vehicles, remains a paramount concern before widespread deployment. A lack of adequate safety is a limiting factor that prevents regulatory approval or acceptance as well as driver or passenger acceptance and adoption of autonomous vehicles. To address and/or alleviate such safety concerns, a computing system creates an enhanced operational design domain (ODD) which encompasses a gamut of navigation contingencies which are addressed under different combinations of conditional constraints. The conditional constraints may include any conditions that may affect navigational safety, and/or cause changes in operational extents of an ego vehicle. An ego vehicle may be implemented as a semi-autonomous or autonomous vehicle (hereinafter “AV”). Operational extents may include permitted actions or restrictions of an ego vehicle. Conditional constraints may include temporal conditions, environmental conditions, traffic conditions, and ego vehicle conditions. In some embodiments, certain conditional constraints may be dependent upon one another. For example, environmental conditions and traffic conditions may be dependent upon temporal conditions such as time of day or day of week. Exemplary figures demonstrate the diversity and richness of contingencies covered within an ODD. An ODD may be specific to each ego vehicle, though some portions of the ODD may be applicable across different ego vehicles.

FIG. 1 is a diagram that illustrates an example implementation of a computing system 102, which may be associated with an ego vehicle. The computing system 102 creates and updates an ODD, which may include or be reflected as one or more datasets (e.g., files or documents). The computing system 102 obtains sensor data, characterizes the sensor data, and performs analysis, such as pattern analysis, on the characterized sensor data. The computing system 102 validates results of the analysis using feedback and validation data. The ego vehicle may include a vehicle (e.g., an AV) that is making locomotive decisions and executing the locomotive decisions while responding to different stimuli. After characterizing the sensor data, or after validation, the computing system 102 creates or updates the ODD. From the ODD, the computing system 102 creates a safety model which may predict, in advance, potential hazards, and accordingly be programmed to react to the potential hazards. In some embodiments, the safety model detects when certain conditional constraints are present and translates the applicable operational extents defined within the ODD into executable commands that are implementable by the ego vehicle.

The computing system 102 obtains sensor data 140 from a multitude of sensors of different modalities, including GPS 141, cameras 142, Lidars 143, radars, sonars, ultrasonic sensors, IMUs (inertial measurement unit), accelerometers, gyroscopes, magnetometers, and FIR (far infrared sensors). The sensors may capture media data and/or data of different formats. The sensor data 140 may include, or be augmented with, map data (e.g., from a high definition (HD) map), textual and/or structured data. The textual data may include accident data indicating a historical frequency of accidents, disengagement data indicating a historical frequency of disengagements, other incident reports, and/or other logs or reports indicative of historical characteristics.

The computing system 102, in step 172, characterizes the sensor data. In some embodiments, characterizing the sensor data may include integrating or fusing the sensor data to transform the disparate data sources into a comprehensive, unified data collection. To integrate the sensor data of different formats, the computing system 102 may normalize the different formats into a standardized format, such as fusing camera and Lidar data. In some embodiments, the integrating of the sensor data may include other data transformations such as data frame construction and/or compressing data. Next, the computing system 102, in step 174, performs pattern analysis on the integrated sensor data to uncover navigational relationship data. During pattern analysis, statistical analysis and machine learning techniques, using machine learning components 111, are applied to the integrated dataset to identify navigational relationship data. The navigational relationship data may include patterns, behaviors, and trends which involve complex and multifactorial interactions between the ego vehicle, other vehicles, other entities within the surroundings, environmental characteristics, infrastructural characteristics, traffic characteristics, and/or vehicle dynamics characteristics.

In step 176, following the uncovering of navigational relationship data from pattern recognition, the computing system 102 obtains feedback and validation data 150 which provides feedback and/or validation regarding the navigational relationship data. The feedback and validation data 150 may be from different sources, such as additional and/or subsequent reports that partially or fully confirm or reject a veracity of the navigational relationship data, from additional analyses using classical and/or machine learning techniques, and/or from simulations of driving scenarios. The feedback and validation data 150 may include additional data related to certain conditional constraints, such as off-road terrains, which previously were not fully addressed within the ODD, and may be used to further refine the operational extents under those conditional constraints. The feedback and validation data 150 may also provide feedback to the machine learning components 111 in order to iteratively train the machine learning components 111. In step 178, the computing system 102 selectively updates the navigational relationship data based on the feedback and validation data 150. Following the feedback and validation, in step 180, the computing system 102 creates or updates the ODD. In step 182, the computing system 102 generates an operational protocol according to the ODD. The operational protocol may be encompassed within a safety model. The operational protocol may include detecting applicable conditional constraints and converting the operational extents corresponding to those conditional constraints into executable commands. The executable commands may be directed to one or more ego vehicle components such as a brake, an actuator, or a steering wheel. The executable commands, when implemented, may include, for example, limiting a force applied to an actuator, or limiting an extent to which a steering wheel turns. In step 184, the computing system 102, or a different computing system, is programmed according to the operational protocol, to regulate the maneuvering and navigation of the ego vehicle.

The implementation in FIG. 1 can include at least one computing device 104 which may be operated by an entity such as a user, and may include or be part of a human machine interface (HMI). The computing device 104 may receive any outputs from the computing system 102 via a network 106, visually render any outputs received, and/or provide inputs or feedback to the computing system 102. In general, the computing device 104 can interact with the database 130 directly or over a network 106, for example, through one or more graphical user interfaces, application programming interfaces (APIs), and/or webhooks running on the computing device 104. The computing device 104 may include one or more processors and memory.

The computing system 102 may include one or more processors 103 which may be configured to perform various operations by interpreting machine-readable instructions, for example, from a machine-readable storage media 112. In some examples, the one or more processors 103 may be combined or integrated into a single processor, and some or all functions performed by one or more of the processors 103 may not be spatially separated, but instead may be performed by a common processor. The one or more processors 103 may be physical or virtual entities. For example, as physical entities, the one or more processors 103 may include one or more processing circuits, each of which can include one or more processing cores. Additionally or alternatively, for example, as virtual entities, the one or more processors 103 may be encompassed within, or manifested as, a program within a cloud environment. The one or more processors 103 may constitute separate programs or applications compared to machine learning components (e.g., the one or more machine learning components 111). The computing system 102 may also include a storage 114, which may include a cache for faster access compared to the database 130.

The one or more processors 103 may further be connected to, include, or be embedded with a logic 113 which, for example, may include, store, and/or encapsulate instructions that are executed to carry out the functions of the one or more processors 103. In general, the logic 113 may be implemented, in whole or in part, as software that is capable of running on the computing system 102, and may be read or executed from the machine-readable storage media 112. The logic 113 may include, as nonlimiting examples, expressions, functions, arguments, evaluations, and/or code. Here, in some examples, the logic 113 encompasses functions of or related to obtaining sensor data, integrating the sensor data, performing pattern analysis on the integrated sensor data to generate navigational relationship data, confirming or updating the navigational relationship data based on the performed pattern analysis, creating or updating an ODD, generating an operational protocol to be applied on the ego vehicle according to the ODD, and performing one or more maneuvering or navigational operations on the ego vehicle based on the operational protocol. Functions or operations described with respect to the logic 113 may be associated with a single processor or multiple processors.

The database 130 may include, or be capable of obtaining, the sensor data 140, the feedback and validation data 150, the characterized sensor data, the navigational relationship data, and/or any intermediate and/or final outputs during the creating or updating of the ODD, and/or the operational protocol.

The computing system 102 may also include, be associated with, and/or be implemented in conjunction with, the machine learning components 111, which may encompass an LLM. The machine learning components 111 may perform unsupervised learning. In some examples, the machine learning components 111 may perform and/or execute functions in conjunction with the logic 113. Thus, any operations or any reference to the machine learning components 111 may be understood to potentially be implemented in conjunction with the logic 113 and/or the computing system 102. The machine learning components 111 may be trained to perform and/or execute certain functions, such as detecting or predicting one or more operational extents corresponding to one or more conditional constraints, and/or outputting navigational relationship data from the characterized sensor data inputs.

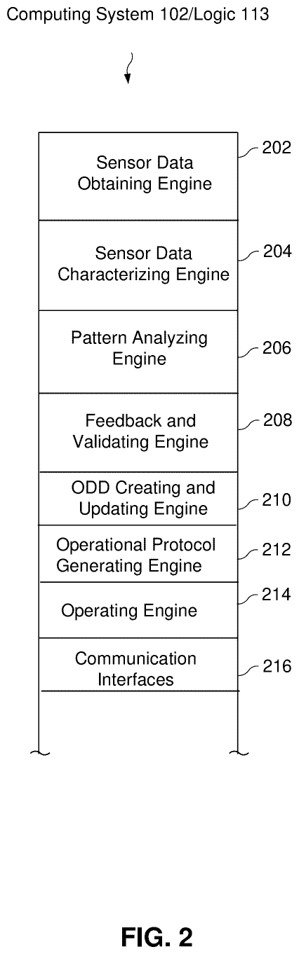

FIG. 2 is a block diagram that depicts an example implementation of the computing system 102 and/or the logic 113, in accordance with some embodiments. The computing system 102 contains hardware, software and/or firmware capable of communicating with any of the aforementioned sensors (e.g., GPS 141, cameras 142, Lidars 143, radars, sonars, ultrasonic sensors, IMUs, accelerometers, gyroscopes, magnetometers, and FIRs) in FIG. 1 and/or the computing device 104. The computing system 102 may communicate with the computing device 104 and/or the sensors via application programming interfaces (APIs). The computing system 102 includes a sensor data obtaining engine 202, a sensor data characterizing engine 204, a pattern analyzing engine 206, a feedback and validation obtaining engine 208, an ODD creating and updating engine 210, an operational protocol generating engine 212, an operating engine 214, and/or one or more communication interfaces 216. FIG. 2 describes the operations of the computing system 102 consistent with FIG. 1, with additional details.

The sensor data obtaining engine 202 is configured to obtain sensor data from one or more sensors within an interior or an exterior of the ego vehicle, such as from the aforementioned sensors, from one or more sensors of one or more different vehicles, from one or more sensors disposed on one or more landmarks such as traffic lights, and/or from other sources.

The sensor data characterizing engine 204 is configured to integrate the obtained sensor data according to step 172 of FIG. 1. The sensor data characterizing engine 204 is configured to further interpret and/or decipher the sensor data, such as obtaining or deriving one or more characteristics from the sensor data. Characteristics may refer to contextual data of different driving scenarios. Here, the term characteristic may be largely interchangeable with the term condition. In some embodiments, characteristic may refer to historical sensor data and characterizations thereof, while condition, or conditional constraint, may refer to what is defined within the ODD, and/or actual ego vehicle operation. The sensor data characterizing engine 204 is configured to avoid false positive and false negative detections.

The characteristics may include operational terrain and location-dependent characteristics such as slope, camber, curvature, banking, coefficient of friction, road roughness, and/or air density. The characteristics may also include environmental and weather characteristics such as surface temperature, air temperature, wind, visibility, precipitation, icing, lighting, glare caused by sunlight angle and/or sunlight intensity, electromagnetic interference, clutter, vibration, other sources of sensor noise, and/or seasonal changes such as a higher concentration of foliage on roads during winter. The characteristics may include infrastructural characteristics such as road types, lane markings, barriers traffic signals, and traffic signage. The infrastructural characteristics may also include availability and placement of operational infrastructure. Operational infrastructure may include operational surfacing, navigation aids such as beacons, lane markings, and/or augmented signage, traffic management devices such as traffic lights, right-of-way signage, vehicle running lights, keep-out zones, special road use rules such as time-dependent lane direction changes, and vehicle-to-infrastructure availability. The operational infrastructure may include permanent obstacles such as structures, curbs, median dividers, guard rails, trees, bridges, tunnels, berms, ditches. The operational infrastructure may include temporary obstacles that are absent from high definition (HD) maps. The temporary obstacles may include transient keep-out zones, spills, falling objects, floods, water-filled potholes, landslides, washed out bridges, overhanging vegetation, and downed power lines.

The characteristics may also include traffic characteristics such as vehicle flow patterns which include average speeds of traffic, traffic densities during different times, and any shock waves. The traffic characteristics may include rules of engagement and expectations for interaction with an environment, such as traffic laws or regulations, social norms, and customary signaling and negotiation procedures with other agents, either autonomous or human. The signaling may be explicit and/or implicit via vehicle motion control. Traffic regulations may include different sign demonstrations in different countries such as blue stop signs, “right turn keep moving” stop sign modifiers, horizontal as opposed to vertical sign orientations, and side-of-road changes.

The traffic characteristics may include behavioral characteristics, such as traffic behaviors of neighboring traffic, including yielding behaviors, pedestrian movement patterns such as common pedestrian crossing points at locations besides designated crosswalks, frequency of prohibited pedestrian crossings at locations other than a crosswalk, animal movement or migration patterns, and historical accident data.

In some embodiments, the behavioral characteristics may include inferred behavioral characteristics such as predicted operational characteristics of other road users. The predicted operational characteristics may include expected behaviors of other road users which may involve a probability distribution and may be based on object classification. The expected behaviors may include or be associated with braking capabilities of other vehicles, a behavior of another vehicle such as an extent of irregularity of the other vehicle behavior, an extent of aggressiveness of the other vehicle, an extent of cooperativeness of the other vehicle, and/or whether the other vehicle has a fault. The predicted operational characteristics may include expected or predicted behaviors of persons such as an extent of cooperativeness of persons, and/or an extent of awareness of persons that a vehicle is autonomous. The predicted operational characteristics may also include identification of at-risk populations, who might be unable to comply with or exempt from following established rules and norms, such as children, injured, ability-impaired, and under-the-influence people.

The characteristics may also include communication modes, bandwidth, latency, stability, availability, and/or reliability, including both machine-to-machine communications and human interaction. The characteristics may also include availability and accuracy of infrastructure characterization data such as granularity of HD maps and identifications of temporary deviations from baseline data. These temporary deviations may include construction zones, detours, and/or temporary traffic zones such as for evacuation from emergency.

The characteristics may include identification of other road users including special purpose vehicles such as ambulances, farm equipment, construction crews, draft animals, farm animals, towing vehicles, and endangered species. The characteristics may include identification of additional equipment or lack thereof such as presence or absence of snowchains on a vehicle, which may indicate an increased probability of uncontrolled slippage or locomotion of another vehicle. The characteristics may include identification of events such as temporary structures, street dining, street festivals, parades, motorcades, and funeral processions.

The pattern analyzing engine 206 is configured to perform pattern analysis on the characterized sensor data in order to identify the navigational relationship data, which includes patterns, behaviors, and trends which uncover complex and multifactorial interactions between the ego vehicle, other vehicles, other entities within the surroundings, environmental characteristics, infrastructural characteristics, traffic characteristics, and/or vehicle dynamics characteristics, and/or any of the previously mentioned characteristics in reference to the sensor data characterizing engine 204.

As a specific example, the pattern analyzing engine 206 may identify that the navigational relationship data indicates that at a given location, rainfall of greater than a threshold level and/or a glare intensity of higher than a threshold intensity causes a drastically higher rate of accidents due in part to impairing of sensor functions and/or locations on vehicles. The pattern analyzing engine 206 may predict glare intensity based on environmental factors such as a time of day, other weather conditions like sunlight angle and cloud cover, and geographical locations. As another specific example, the pattern analyzing engine 206 may identify navigational relationship data that indicates that at a given location, yielding behaviors or overall driving behaviors of vehicles are different, which affects interaction data between vehicles such as post-encroachment time, time-to-collision, and/or safe time headway. The identified navigational relationship data, upon validation, is built into the ODD in order to more granularly define operational extents of the ego vehicle.

The pattern analyzing engine 206 may include and/or be associated with the machine learning components 111 in addition to computing components (e.g., the processors 103) that primarily perform classical techniques. In some embodiments, machine learning techniques may be combined with classical techniques to identify the navigational relationship data corresponding to environmental characteristics or relationships among the characteristics. For example, supervised learning algorithms such as Random Forests and/or Gradient Boosting may predict glare intensity based on environmental factors like sunlight angle, cloud cover, time of day, weather characteristics, and/or geographic location. Additionally or alternatively, classical techniques such as correlation analysis identify relationships between glare intensity and environmental variables. For instance, statistical tests like Pearson correlation coefficient quantify the degree of correlation between glare intensity and factors like sunlight angle or cloud cover.

In some embodiments, machine learning techniques may be combined with classical techniques to identify the navigational relationship data corresponding to traffic characteristics. For example, time-series analysis techniques, such as Long Short-Term Memory (LSTM) networks or Gaussian Processes, may model the temporal dynamics of traffic speed throughout the day. The models may learn traffic flow patterns and predict average speeds during different time intervals. Additionally or alternatively, histogram analysis can be employed to visualize the distribution of traffic speeds over time. Statistical measures like mean, median, and standard deviation can quantify central tendencies and variability in traffic speed to identify peak traffic times and congestion patterns.

In some embodiments, machine learning techniques may be combined with classical techniques to identify navigational relationship data corresponding to pedestrian characteristics. As an example, object detection algorithms, like YOLO (You Only Look Once), Faster R-CNN, or BEVFormer can be trained to detect and track pedestrian movements from video data. By analyzing trajectories, the machine learning techniques can identify common crossing points and patterns of pedestrian behavior. Meanwhile, statistical techniques may perform cluster analysis to group pedestrian trajectories into clusters representing common crossing points or routes. Techniques such as k-means clustering may identify spatial patterns in pedestrian movement, including frequent crossing locations not designated as crosswalks. As evident from the previous examples, combining machine learning and classical techniques increase the granularity of detected relationships, leading to more precise and safe operation of the ego vehicle, which accounts for latent dangers that may not be readily apparent.

After navigational relationship data has been identified from the pattern analyzing engine 206, the feedback and validating engine 208 is configured to obtain the feedback and validation data 150. The feedback and validation data 150 provides feedback and/or validation regarding an extent of accuracy of the navigational relationship data. The feedback and validation data 150 may include additional sensor data, additional textual data such as log data, and/or inputs from one or more users obtained from the computing device 104. The feedback and validating engine 208 may generate updated training datasets in order to iteratively train the machine learning components 111 to more accurately detect relationships and uncover the navigational relationship data. The feedback and validating engine 208 selectively updates or refines the navigational relationship data based on the feedback and validation data 150. For example, the navigational relationship data may have indicated that a sunlight angle below a threshold angle is associated with a highest degree of accidents. In this example, the feedback and validation data 150 may provide further elaboration of the navigational relationship data by indicating that a combination of a certain level of precipitation and the sunlight angle below the threshold angle is associated with a highest degree of accidents.

In some embodiments, the feedback and validating engine 208 may obtain additional navigational relationship data that includes more thorough characterization of new or unknown driving scenarios that were previously not fully characterized. For example, the feedback and validating engine 208 may obtain the additional navigational relationship data regarding one or more driving scenarios such as off-road terrains.

In some embodiments, the feedback and validating engine 208 may obtain additional performance data regarding performance of the ego vehicle according to a currently implemented ODD. The additional performance data may include safety-related parameters while the ego vehicle is operating. These safety-related parameters may include following distance to other vehicles, time-to-collision, time-to-accident, post-encroachment time, deceleration-to-safety-time, and/or disengagement data. The feedback and validating engine 208 may detect and record instances in which certain safety-related parameters fall outside of safe operating ranges, and/or instances when disengagements occur. This additional performance data may be used to update the ODD if the ego vehicle is operating unsafely using the currently implemented ODD or operating outside of safety tolerances. The ODD may be iteratively updated until the safety-related parameters are within the safety tolerances.

After the feedback and validation data 150 has been obtained, the ODD creating and updating engine 210 is configured to create and/or update an ODD based on the navigational relationship data, any updates in the navigational relationship data, and/or the additional feedback data obtained by the feedback and validating engine 208. In some embodiments, the created and/or updated ODD contains an operational extent map which maps different combinations of conditional constraints to operational extents (e.g., permitted vehicle actions, or restrictions) of an ego vehicle. The conditional constraints, as previously mentioned, may include environmental conditions, traffic conditions, and ego vehicle conditions, and/or may correspond to any of the characteristics described in relation to the sensor data characterizing engine 204.

The operational extent map may be based on an ontological framework or template (hereinafter “framework”). This ontological framework may include links or associations, or inferred links, between a combination of conditional constraints and operational extents of an ego vehicle. The ontological framework may further categorize certain combinations of conditional constraints. For example, the ontological framework may categorize conditional constraints including heavy rain, heavy fog, or heavy snow under inclement or severe conditions, and medium rain, medium fog, or medium snow under mild conditions. The ontological framework may link inclement conditions to a first set of restrictions in ego vehicle operations such as reduced maximum speeds or reduced turning speeds. The ontological framework may link mild conditions to a second set of restrictions that are more relaxed compared to the first set of restrictions. The set of restrictions mapped by the ontological framework may be based on a probability of an accident, a probability of a disengagement, and/or a predicted severity of an accident under a given combination of conditional constraints.

In some embodiments, additionally or alternatively, the operational extent map may include a hierarchical organization of conditional constraints. Such a hierarchical organization of conditional constraints may map different levels of granularity of conditional constraints to corresponding permitted ego vehicle actions and/or ego vehicle restrictions. For example, if the conditional constraints are based on location then a first set of broader permitted ego vehicle actions may be applied for a broader classification of the location, such as a state. Within a more specific classification of the location such as a county, a second set of narrower permitted ego vehicle actions may be applied. Any restrictions within a broader classification (e.g., the state) may be inherited for the narrower classification (e.g., the county). For example, the first set of broader permitted ego vehicle actions may include permitting an ego vehicle to drive at speeds up to 60 miles per hour within the state. Within a county, the second set of narrower permitted ego vehicle actions may include permitting an ego vehicle to drive at speeds up to 50 miles per hour or may further include regulations of turning speeds. As another example, if the conditional constraints are based on weather conditions, then a first set of broader permitted ego vehicle actions may be applied for a broader classification of the weather condition, such as an inclement weather condition. A second set of narrower permitted ego vehicle actions may be applied for a narrower classification of the weather condition, such as heavy rain.

In some embodiments, the ODD defines operational extents under other contingencies such as if an accident or a fault were to occur or is unpreventable, in order to mitigate a severity of the accident or the fault. For example, such mitigation may include taking measures to reduce a probability of a multi-car accident and/or or reduce an impact of an unavoidable accident such as tightening seat belts.

The operational protocol generating engine 212 may be configured to translate any of the operational extents within the operational extent map into executable commands that are implementable by the ego vehicle. For example, assume, arguendo, that the operational extent map specifies that if a certain weather or environmental condition is detected, the ego vehicle is restricted from going above a certain threshold speed, and/or restricted from making a turn that is less than a certain radius of curvature. The operational protocol generating engine 212 may translate these restrictions into specific commands, to be implemented at specific times, at physical ego vehicle components such as an ego vehicle actuator, brake, and/or steering wheel. In some embodiments, the operational protocol generating engine 212 may perform planning or scheduling of specific ego vehicle navigation actions in accordance with the operational extent map.

The operating engine 214 may be configured to implement the specific commands at the physical ego vehicle components in order to maneuver the ego vehicle in accordance with the ODD.

The communication interfaces 216 may include APIs and be configured to communicate between the computing system 102, the ego vehicle, and any other external sources. For example, the communication interfaces 216 may be configured to communicate with one or more sensors to obtain the sensor data 140, and communicate with the physical ego vehicle components in order to maneuver the ego vehicle.

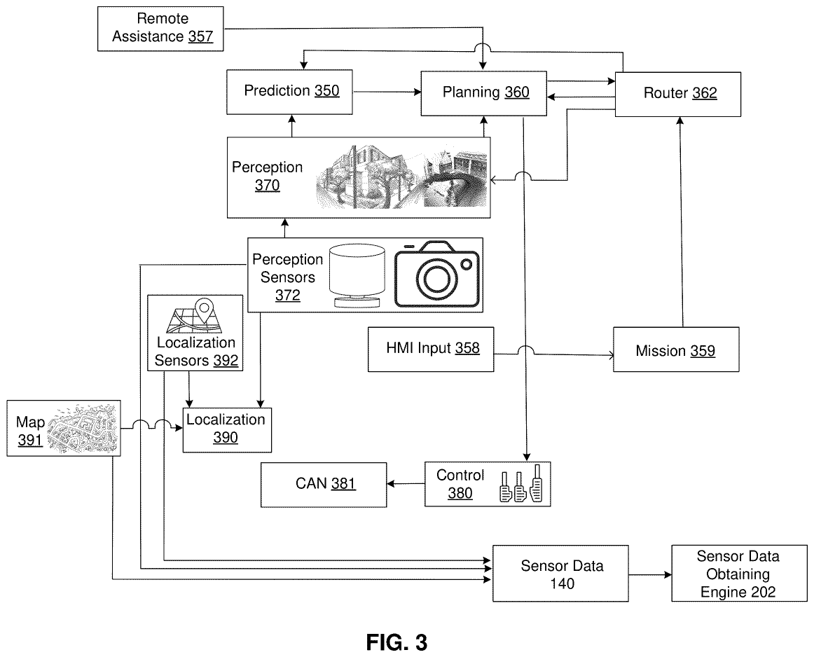

FIG. 3 illustrates an example implementation of the computing system 102 that obtains the sensor data 140, in context with other components of the ego vehicle, which may be part of the computing system 102 or separate from the computing system 102. The other components may provide navigational related (herein “navigational”) data to the computing system 102 or obtain navigational data as part of the computing system 102. In some embodiments, FIG. 3 provides a similar perspective as FIG. 1 and FIG. 2 and may be implemented in conjunction with FIG. 1 and FIG. 2. The navigational data may include raw and/or processed data, and may be manifested in different formats, including textual data, media data, binary data, unstructured data, and/or structured data. The other components may include a prediction source 350, a planning source 360, a perception source 370, a control source 380, a localization source 390, and/or a router 362.

The perception source 370 may be implemented as part of the sensor data obtaining engine 202 and/or the sensor data characterizing engine 204. To summarize, the perception source 370 may obtain and/or process sensor data from perception sensors 372, which may include sensors of different modalities including any of Lidar, camera, radar, ultrasonic, sonar, and/or far infrared (FIR) sensors as mentioned in FIG. 1. The perception sensors 372 may work in conjunction with any localization sensors described. The perception source 370 may combine, merge, or fuse data from different modalities. The perception source 370 may perform entity recognition, for example, based on semantic segmentation and/or instance segmentation. The perception source 370 may thus recognize entities and attributes thereof, including locations and characteristics of the entities.

The perception source 370 may feed or provide outputs to the prediction source 350 and/or the planning source 360. The prediction source 350 may be implemented as part of the pattern analyzing engine 206. In some embodiments, the prediction source 350 may predict one or more trajectories and/or behaviors of entities that were captured by the perception source 370 using one or more models such as machine learning models or classical models and depending on types and/or historical behaviors of the entities. The prediction source 350 may feed or provide outputs to the planning source 360.

The planning source 360 may be implemented as part of the operational protocol generating engine 212 and plan one or more actions, such as navigation or locomotive actions which may encompass planning a route based on the outputs from the perception source 370 and/or the prediction source 350, and/or planning actuation-related actions such as changing lanes, braking, and/or accelerating, or controlling modes such as cruise control (e.g., adaptive cruise control, intelligent cruise control). The planning source 360 may obtain outputs of a remote assistance source 357 which may be external to the ego vehicle. For example, the planning source 360 may obtain indications of remote operations such as tele assistance or teleoperations, and accordingly modify plans. The control source 380 may receive outputs from the planning source 360. The control source 380 may implement any of, or a subset (e.g., a portion) or all of the actions planned by the planning source 360. In some embodiments, implementation of the ODD may override existing planned actions from the planning source 360 and the control source 380.

The localization source 390 may obtain information from localization sensors 392, from the perception sensors 372, and/or geospatial information such as a map 391. The localization sensors 392 may include global navigation satellite system (GNSS) sensors, inertial measurement unit (IMU), accelerometers, gyroscopes, and magnetometers, which may identify a current location of the ego vehicle. The map 391 may include a standard definition (SD) or high definition (HD) map. The computing system 102 may, as a sanity check, compare one or more outputs of the perception sensors 372 to any entities, such as static entities, on the map 391. For example, if the map 391 illustrates an entity such as a traffic sign at a particular location but that entity is undetected by the perception sensors 372, the computing system 390 may determine a possible failure, malfunction, and/or lack of calibration of the perception sensors 372. The computing system 102 may either transmit this indication of a potential issue to the perception sensors 372 or to a controller area network (CAN) agent 381.

The control source 380 may be connected to the CAN agent 381, which may be part of or include a CAN bus. In some embodiments, the control source 380 may be implemented as part of the operating engine 214. The CAN agent 381 may communicate with other controllers (e.g., microcontrollers) and devices associated with the ego vehicle, and/or may generate reports pertaining to ego vehicle operations and statuses. The router 362 may provide connection to other external entities and/or may create a vehicle area network (VAN). Meanwhile, an HMI input 358, which may be obtained from the computing device 104, may provide a mission 359 which includes an intended destination.

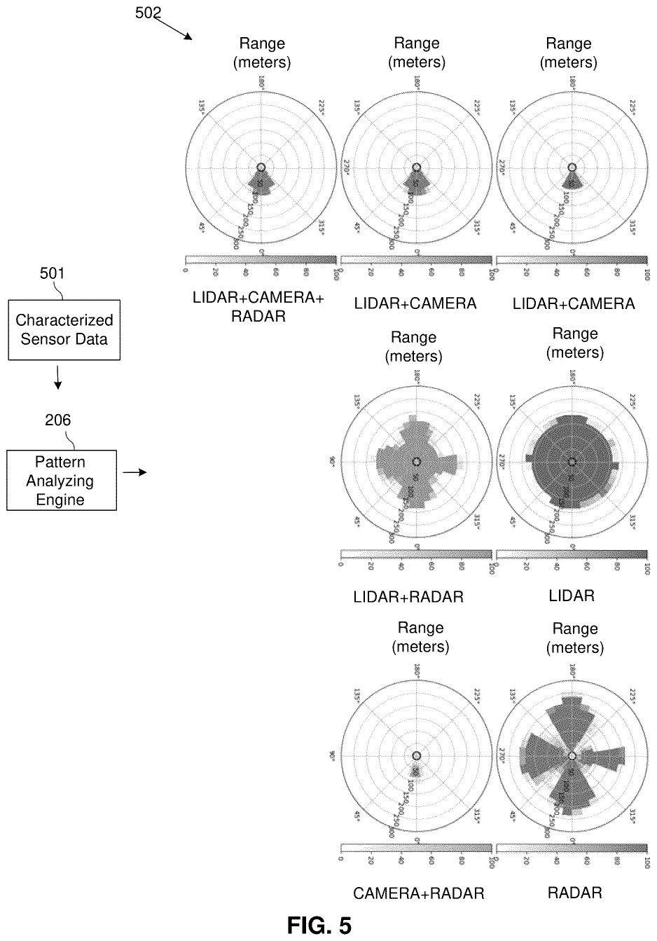

FIGS. 4-5 are diagrams illustrating implementations of the pattern analyzing engine 206. In FIG. 4, the pattern analyzing engine 206 obtains historical characterized sensor data 401 from the sensor characterizing engine 204, and generates analysis results 402 and 403 which includes interaction data that includes safety-related parameters related to interactions between ego vehicles and other agents (e.g., other vehicles, pedestrians, and/or animals). The historical characterized sensor data 401 may include data from the same ego vehicle as mentioned in FIG. 1, or different ego vehicles. The historical characterized sensor data 401 may include data in which no disengagements or no accidents have occurred. The analysis results 402 and 403 may reflect a different portion of the historical characterized sensor data 401. The analysis results 402 and 403 includes histogram analyses that indicates typical interaction patterns between vehicles and agents. The analysis results 402 include distributions of safety-related parameters, which include interaction or speed-related parameters including speed of the ego vehicle, a proximity or time gap between the ego vehicle and a nearest agent, and a response time or a time-to-collision between the ego vehicle and the nearest agent. The analysis results 403 include distributions of safety-related parameters including speed of an agent, a proximity or time gap between the agent and a nearest ego vehicle, and a response time or a time-to-collision between the agent and the nearest ego vehicle.

In FIG. 5, the pattern analyzing engine 206 obtains historical characterized sensor data 501 from the sensor characterizing engine 204. The historical characterized sensor data 501 may include an indication of agents, as well as distances and/or orientations of the agents with respect to the ego vehicle, that are detectable by one or a combination of sensors. The pattern analyzing engine 206 generates analyses 502 to interpret sensor ranges and detection capabilities of one or more sensors under various environmental characteristics. The pattern analyzing engine 206 assesses distributions of agents captured around the ego vehicle and any sensor blind spots. The analyses 502 may be applied to determine a configuration of sensors that is capable of capturing agents at a sufficient level of granularity for safe driving operations. The analyses 502 may also be applied to determine a suitable, or best performing, configuration of sensors applicable for specific environmental characteristics, or across different environmental characteristics.

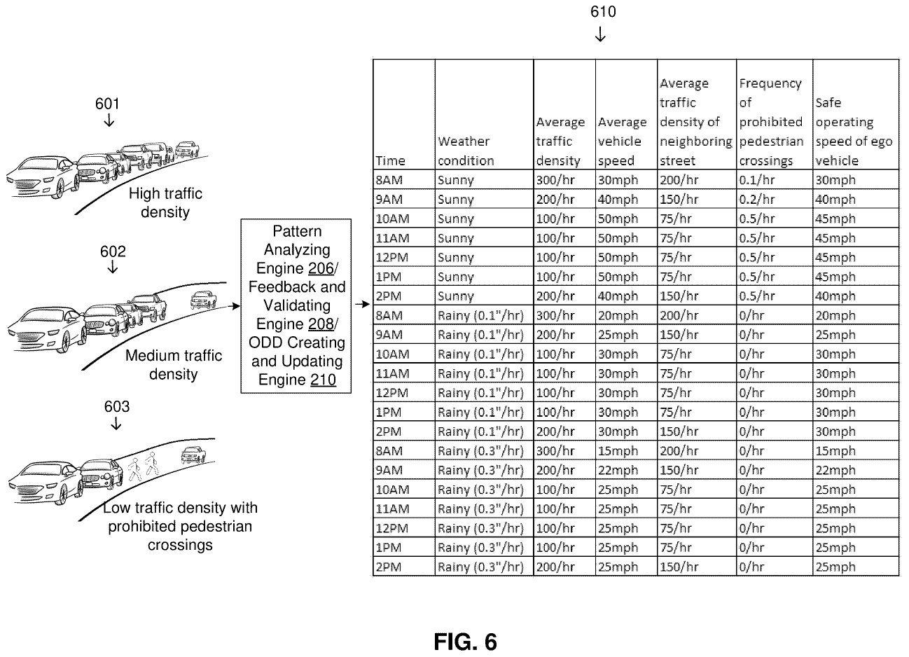

FIGS. 6-11 are diagrams illustrating creation of an ODD under different conditional constraints. FIG. 6 is a diagram illustrating creation of an ODD under a combination of different temporal conditions, traffic conditions, agent behavioral conditions, and environmental conditions. In FIG. 6, the pattern analyzing engine 206 may obtain characterized sensor data 601, 602, 603 that includes a combination of characteristics, including different temporal, traffic and environmental characteristics. For example, one set of characterized sensor data 601 may include driving scenarios associated with characteristics of high traffic density with different amounts of precipitation at different times of a day. Another set of characterized sensor data 602 may include driving scenarios associated with characteristics of medium traffic density with different amounts of precipitation at different times of a day. Another set of characterized sensor data 603 may include driving scenarios associated with characteristics of low traffic density with prohibited pedestrian crossings and different amounts of precipitation at different times of a day. The characterized sensor data 601, 602, 603 may include non-accident data and accident data, and include safety-related parameters (e.g., interaction and speed-related parameters) such as speed of the ego vehicle, a time gap between the ego vehicle and a nearest agent, and a time-to-collision between the ego vehicle and the nearest agent. The pattern analyzing engine 206 may assess how each of the characteristics affect the safety-related parameters, and therefore, how each of the characteristics lead to safe or unsafe interactions among ego vehicles and agents. Safe interactions may mean an absence of accidents and an absence of disengagements, an accident frequency or disengagement frequency of less than a threshold frequency, or satisfaction of at least a safety tolerance which includes a sufficient response time for the ego vehicle. For example, safe interactions may include, under a driving scenario of sunny weather conditions and an average traffic density of 300 vehicles per hour, and with an average vehicle speed of 30 miles per hour, a safe operating speed of the ego vehicle being at most 30 miles per hour. Unsafe interactions may mean accidents or disengagements have occurred under that driving scenario or that the accident frequency or the disengagement frequency under that driving scenario exceeds a threshold frequency. For example, unsafe interactions may include, under the previously mentioned driving scenario, the ego vehicle driving at over 50 miles per hour. From the characterized sensor data 601, 602, 603, the pattern analyzing engine 206 may infer a nexus between each of the characteristics and safe or unsafe interactions, and identify which characteristics are most likely to lead to safe or unsafe interactions of the ego vehicle.

From the pattern analysis of the characterized sensor data 601, 602, 603, and in some embodiments, following feedback obtained from the feedback and validating engine 208, the ODD creating and updating engine 210 may define, as part of an ODD, operational extents of an ego vehicle that indicate extents of safe operation of the ego vehicle. In some embodiments, the ODD may include or be represented as a dataset 610 or a portion thereof. Operational extents may indicate whether the ego vehicle is operational at all under certain conditional constraints, and if operational, then an extent of the operation or settings under which the ego vehicle is operational. For example, the operational extents may include safe operating speeds of the ego vehicle under the different combinations of conditional constraints, as illustrated in the last column of the dataset 610. The operational extents may be evaluated based on a measure of safety for the ego vehicle and other agents, a reduction of wear and tear and probability of maintenance for the ego vehicle, fleet efficiency, and/or impacts on traffic flow. The operational extents include operations of the ego vehicle that have at least a threshold likelihood of resulting in safe interactions with other agents, and/or provide at least a safety tolerance to give sufficient time for responding to unexpected occurrences. The operational extents are determined based on how each of the characteristics, or combinations thereof, affect safe or unsafe interactions of the ego vehicle. The ODD is not construed to be limited to defining speed restrictions of the ego vehicle. Other restrictions defined within the ODD include, but are not limited to, restrictions on turning speeds, turning angles, or requirements of activating backup and/or additional sensors or other augmented functionalities (e.g., ADAS) in driving scenarios of heightened danger. Other restrictions include handing over control to a human driver, such as a safety driver, or a requirement to pull over safely.

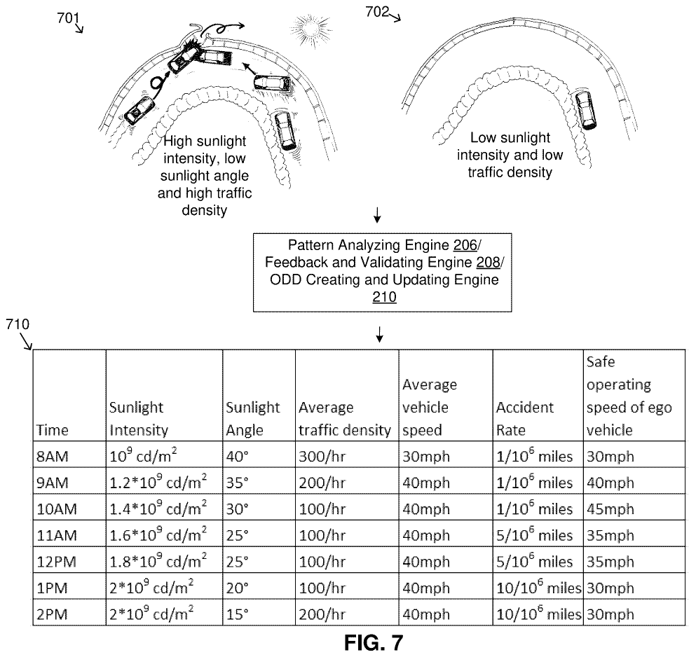

FIG. 7 is a diagram illustrating creation of an ODD under a combination of different temporal conditions, traffic conditions and environmental conditions, such as sunlight intensity and sunlight angles. In FIG. 7, the pattern analyzing engine 206 may obtain characterized sensor data 701, 702 that includes combinations of different temporal, traffic and environmental characteristics. For example, one set of characterized sensor data 701 may include characteristics of high sunlight intensity and low sunlight angle with different traffic densities. Another set of characterized sensor data 702 may include characteristics of low sunlight intensity with different traffic densities. The characterized sensor data 701, 702 includes non-accident data and accident data, and includes safety-related parameters (e.g., interaction and speed-related parameters) such as speed of the ego vehicle, a time gap between the ego vehicle and a nearest agent, a time-to-collision between the ego vehicle and the nearest agent, and an accident rate or frequency. The pattern analyzing engine 206 may assess how each of the characteristics affect the safety-related parameters, and therefore, how each of the characteristics lead to safe or unsafe interactions among ego vehicles and agents.

From the pattern analysis of the characterized sensor data 701, 702, and in some embodiments, following feedback obtained from the feedback and validating engine 208, the ODD creating and updating engine 210 may define, as part of an ODD, operational extents of an ego vehicle. The operational extents are determined based on how each of the characteristics, or combinations thereof, affect safe or unsafe operations of the ego vehicle. In some embodiments, the ODD may include or be represented as a dataset 710. For example, the operational extents may include safe operating speeds of the ego vehicle under the different combinations of conditional constraints, as illustrated in the last column of the dataset 710. The ODD is not construed to be limited to speed restrictions of the ego vehicle. Other restrictions include, but are not limited to, restrictions on turning speeds, turning angles, or requirements of activating backup and/or additional sensors or other augmented functionalities in driving scenarios of heightened danger.

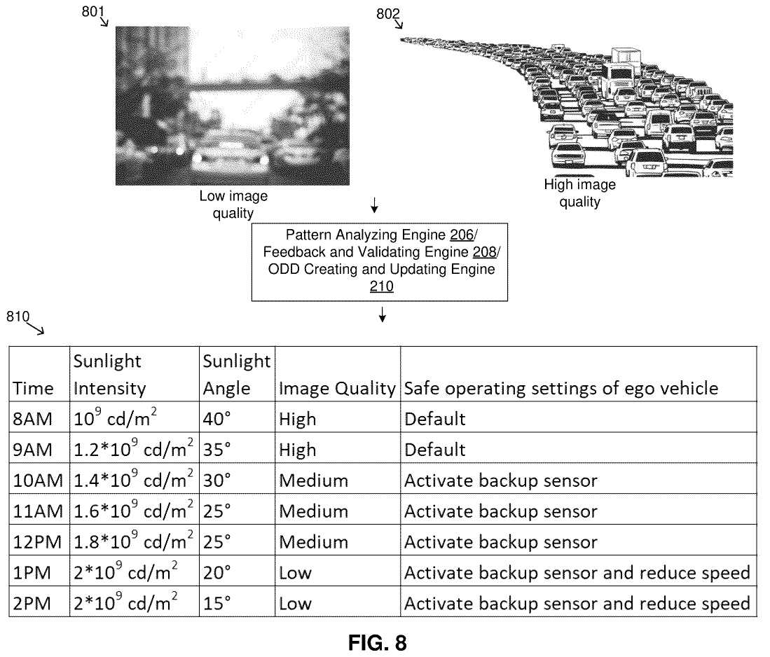

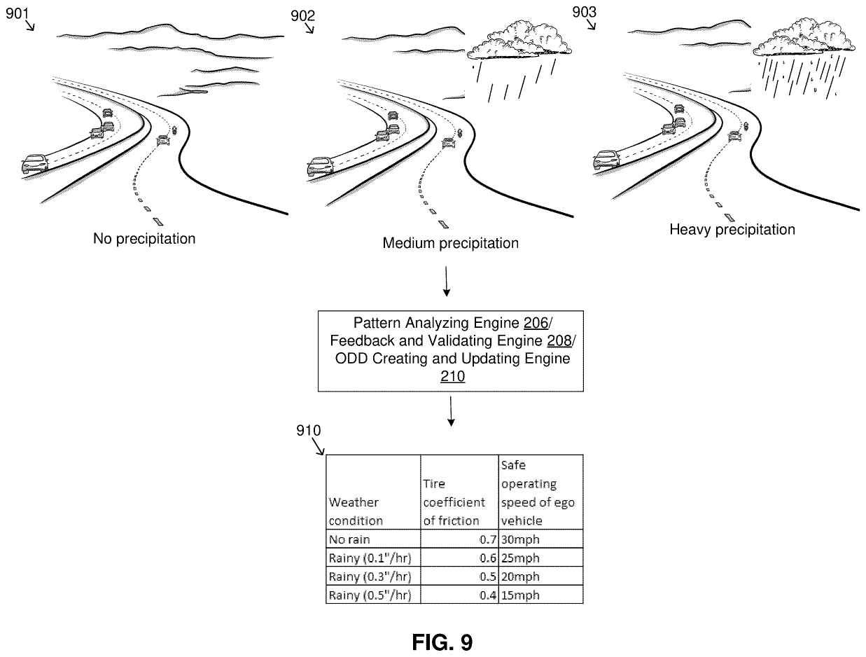

FIGS. 8-9 are diagrams illustrating creation of an ODD that covers different environmental conditions, which affect operation of vehicle components such as sensors and tires. FIGS. 8-9 illustrate similar principles as FIGS. 6-7, but include a direct mapping of an impact of environmental conditions to functionality of vehicle components (e.g., safety-related parameters of vehicle components) that affect operational extents of an ego vehicle. In FIG. 8, the pattern analyzing engine 206 may obtain characterized sensor data 801, 802 that includes combinations of different temporal and environmental characteristics. For example, one set of characterized sensor data 801 may include a combination of characteristics of a given sunlight intensity and a given sunlight angle, or ranges thereof. Another set of characterized sensor data 802 may include a combination of characteristics of a different sunlight intensity and a given sunlight angle, or ranges thereof. The pattern analysis engine 206 may assess how each of the combination of characteristics affects an image quality of a sensor output, a sensor range, or other sensor attributes indicative of an extent of sensor functionality. For example, the pattern analysis engine 206 may assess, from the characterized sensor data 801, 802, that at a given combination of sunlight intensity and sunlight angle, image quality of a sensor becomes low. The pattern analysis engine 206 may additionally assess how sensor attributes affect the safety-related parameters (e.g., interaction and speed-related parameters) such as interaction and speed-related parameters of an ego vehicle. For example, the pattern analysis engine 206 may determine how a partially broken sensor affects a time gap or a time-to-collision between an ego vehicle and a nearest agent.

From pattern analysis of the characterized sensor data 801, 802, and in some embodiments, following feedback obtained from the feedback and validating engine 208, the ODD creating and updating engine 210 may define, as part of an ODD, operational extents of an ego vehicle depending on image quality or other measures of sensor functionality. In some embodiments, the ODD may include or be represented as a dataset 810. For example, the operational extents may include sensor configurations depending on an extent of sensor functionalities. If image quality is high, indicating an uncompromised sensor functionality, then the operational extent includes default sensor configurations in which backup or additional sensors or functionalities are inactive. If image quality is medium, indicating a partially compromised sensor functionality, then the operational extent includes operating the ego vehicle only when backup or redundant sensors are activated. If image quality is low, indicating a compromised sensor functionality, then the operational extent includes a requirement to operate the ego vehicle when backup sensors are activated and under a reduction of driving speeds.

In FIG. 9, the pattern analyzing engine 206 may obtain characterized sensor data 901, 902, 903 that includes combinations of different environmental characteristics. For example, one set of characterized sensor data 901 may include driving scenarios with characteristics of no precipitation. Another set of characterized sensor data 902 may include driving scenarios with environmental characteristics of medium precipitation levels. Another set of characterized sensor data 903 may include characteristics of heavy precipitation levels. The pattern analysis engine 206 may assess how each of the characteristics affects operations of specific vehicle components, such as tires. For example, the pattern analysis engine 206 may assess how different precipitation levels affects a tire coefficient of friction, or other tire attribute indicative of an extent of tire functionality. For example, the pattern analysis engine 206 may infer that as the amount of precipitation increases, the tire coefficient of friction becomes lower. The pattern analysis engine 206 may additionally assess how tire coefficient of friction affects safety-related parameters (e.g., interaction and speed-related parameters) of an ego vehicle.

From pattern analysis of the characterized sensor data 901, 902, 903, and in some embodiments, following feedback obtained from the feedback and validating engine 208, the ODD creating and updating engine 210 may define, as part of an ODD, operational extents of an ego vehicle depending on coefficient of friction of tires or other measures of tire functionality. In some embodiments, the ODD may include or be represented as a dataset 910. For example, the operational extents may include permitted operating speeds of the ego vehicle. As a tire coefficient of friction with a given road surface decreases, the ODD creating and updating engine 210 may define additional restrictions such as decreased permitted operating speeds of the ego vehicle, decreased turning speeds, or decreased turning angles.

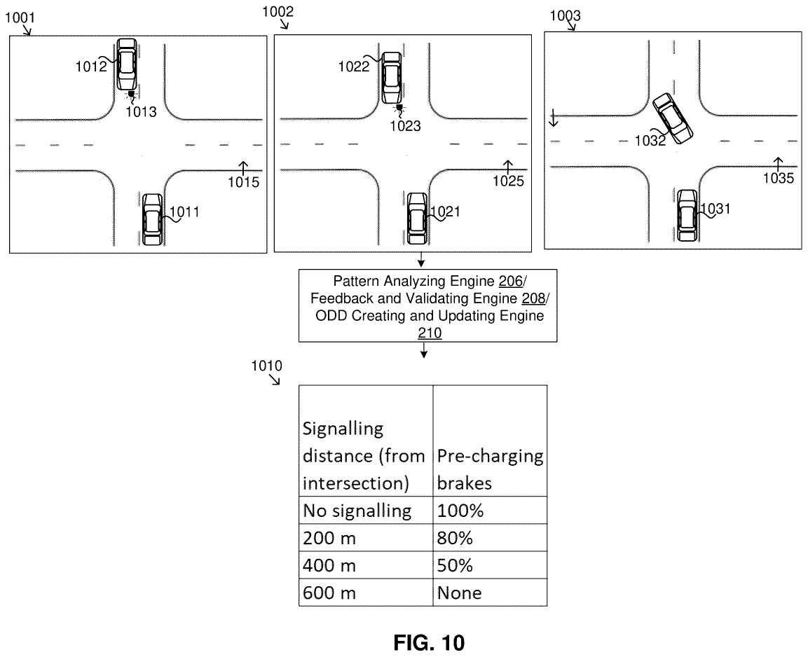

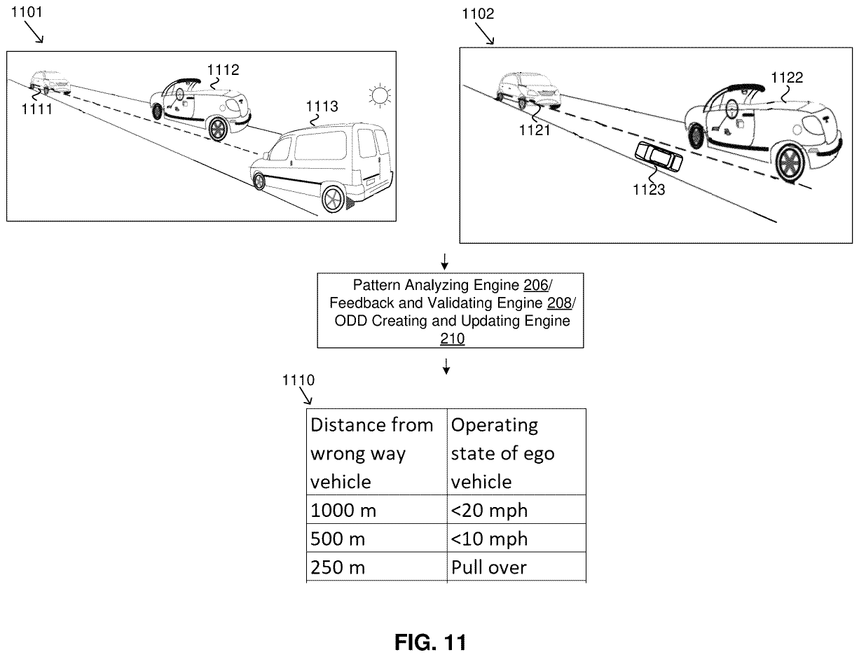

FIGS. 10-11 are diagrams illustrating creation of an ODD that covers different driving behaviors. In FIG. 10, the pattern analyzing engine 206 may obtain characterized sensor data 1001, 1002, 1003 that includes different behavior characteristics such as signaling behaviors. For example, one set of characterized sensor data 1001 may include driving scenarios in which signaling occurs at an acceptable distance prior to turning. Another set of characterized sensor data 1002 may include driving scenarios in which signaling occurs at a shortened distance prior to turning. Another set of characterized sensor data 1003 may include driving scenarios in which no signaling occurs prior to turning. In an example of the characterized sensor data 1001, an ego vehicle 1011 is traveling in an opposite direction compared to another vehicle 1012. The other vehicle is flashing turn signals 1013 to signal an intention to turn onto a lane 1015. In one example of the characterized sensor data 1002, an ego vehicle 1021 is traveling in an opposite direction compared to another vehicle 1012. The other vehicle is flashing turn signals 1013 to signal an intention to turn onto a lane 1015. In an example of the characterized sensor data 1002, an ego vehicle 1021 is traveling in an opposite direction compared to another vehicle 1022. The other vehicle 1022 is flashing turn signals 1023 to signal an intention to turn onto a lane 1025, but at a shorter distance compared to the turn signals 1013 of the other vehicle 1012. In an example of the characterized sensor data 1003, an ego vehicle 1031 is traveling in an opposite direction compared to another vehicle 1032. The other vehicle 1032 is turning onto a lane 1035 without flashing any turn signals.

The pattern analysis engine 206 may assess how signaling behaviors of other vehicles affect interaction and speed-related parameters of an ego vehicle. For example, the pattern analysis engine 206 may determine a relationship between a signaling distance of another vehicle to a frequency or probability of emergency braking. The pattern analysis engine 206 may determine that in a driving scenario with a shortened signaling distance or with no signaling at all, the probability of emergency braking is increased.

From pattern analysis of the characterized sensor data 1001, 1002, and 1003, and in some embodiments, following feedback obtained from the feedback and validating engine 208, the ODD creating and updating engine 210 may define, as part of an ODD, operational extents of an ego vehicle, depending on behaviors of other agents. The ODD creating and updating engine 210 may determine that due to a higher probability of emergency braking in situations of no signaling, limited signaling, or shortened signaling distance, that the ego vehicle is required to pre-charge its brakes. In some embodiments, pre-charging brakes may refer to a faster response in an event that the brakes are applied. Pre-charging brakes may include having brake linings adjoining a brake disk or brake drum without deceleration, until the brakes are pressed. In this manner, if the brakes are pressed, pre-charging of the brakes causes deceleration of the ego vehicle at a more rapid rate.

In some embodiments, the ODD may include or be represented as a dataset 1010. The operational extents may include different extents of pre-charging of the brakes depending on whether signaling of an opposite side vehicle is observed, and/or a distance from an intersection at which signaling is observed. In some embodiments, in accordance with the ODD, if no signaling is observed as an opposite side vehicle approaches an intersection, the brakes of the ego vehicle are to be fully pre-charged to prepare for a contingency that the opposite side vehicle is going to cross a path of the ego vehicle while turning.

In FIG. 11, the pattern analyzing engine 206 may obtain characterized sensor data 1101, 1102 that includes different behavior characteristics such as wrong way driving behaviors. For example, one set of characterized sensor data 1101 may include driving scenarios in which a wrong way vehicle is approaching. Another set of characterized sensor data 1102 may include driving scenarios in which a wrong way vehicle is approaching at a closer distance compared to the characterized sensor data 1101. In an example of the characterized sensor data 1101, an ego vehicle 1111 is traveling in an opposite direction compared to another vehicle 1112. A wrong way vehicle 1113 is approaching the ego vehicle 1111. In an example of the characterized sensor data 1102, an ego vehicle 1121 is traveling in an opposite direction compared to another vehicle 1122. A wrong way vehicle 1123 is approaching the ego vehicle 1121 at a closer distance.

The pattern analysis engine 206 may assess how wrong way driving behaviors of other vehicles affect safety-related parameters (e.g., interaction and speed-related parameters) of an ego vehicle or of other vehicles driving in the correct direction. For example, the pattern analysis engine 206 may determine a relationship between an occurrence of wrong way driving, or a distance from a wrong-way vehicle, to a frequency or probability of emergency braking. For example, the pattern analysis engine 206 may determine how wrong way driving affects traffic flow.

From pattern analysis of the characterized sensor data 1101, 1102, and in some embodiments, following feedback obtained from the feedback and validating engine 208, the ODD creating and updating engine 210 may define, as part of an ODD, operational extents of an ego vehicle, depending on an occurrence of wrong way driving. The ODD creating and updating engine 210 may define the operational extents based on safety considerations for the ego vehicle and other agents, and/or based on a minimum or reduced impact on traffic flow. In some embodiments, the ODD may include or be represented as a dataset 1110. The dataset 1110 may define requirements to slow down if a wrong way driver is approaching within a first threshold distance, and to pull over, stop, or otherwise avoid the wrong way driver if a wrong way driver is approaching within a second threshold distance.

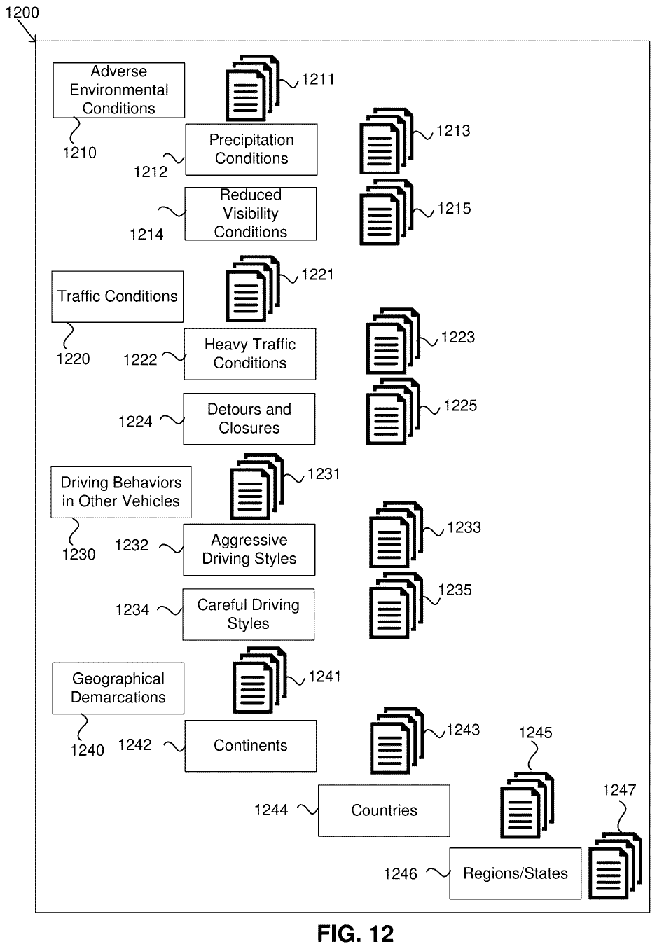

FIG. 12 illustrates an example representation 1200 of an ODD. The representation 1200 may include one or more datasets indicating operational extents of an ego vehicle under conditional constraints, which may be organized or partitioned hierarchically. Different organizations of the ODD are also contemplated. The representation 1200 may include conditional constraints 1210 which define a broad classification or category of adverse environmental conditions, and more specific conditional constraints 1212 and 1214 which may be subclassifications or subcategories of the conditional constraints 1210. Operational extents 1211, 1213, and 1215 may correspond to the conditional constraints 1210, 1212, and 1214, respectively. The operational extents 1213 and 1215 may inherit the operational extents 1211. For example, the operational extents 1211 may include maximum speed restrictions of an ego vehicle. The operational extents 1213 and 1215 may include even more stringent maximum speed restrictions and/or other restrictions in addition to the restrictions already defined within the operational extents 1211.

In a similar principle, conditional constraints 1220 may define a broad classification or category of traffic conditions. More specific conditional constraints 1222 and 1224 may be subclassifications or subcategories of the conditional constraints 1220. Operational extents 1221, 1223, and 1225 may correspond to the conditional constraints 1220, 1222, and 1224, respectively. In a similar principle, conditional constraints 1230 may define a broad classification or category of driving behaviors. More specific conditional constraints 1232 and 1234 may be subclassifications or subcategories of the conditional constraints 1230. Operational extents 1231, 1233, and 1235 may correspond to the conditional constraints 1230, 1232, and 1234, respectively. In a similar principle, conditional constraints 1240 may define a broad classification or category of geographical demarcations, which may define vehicle operations depending on a geographical location of an ego vehicle. More specific conditional constraints 1242 may be subclassifications or subcategories of the conditional constraints 1240. Even more specific conditional constraints 1244 may be subclassifications or subcategories of the conditional constraints 1242. Even more specific conditional constraints 1246 may be subclassifications or subcategories of the conditional constraints 1244. Operational extents 1241, 1243, 1245, 1247 may correspond to the conditional constraints 1240, 1242, 1244, and 1246, respectively.

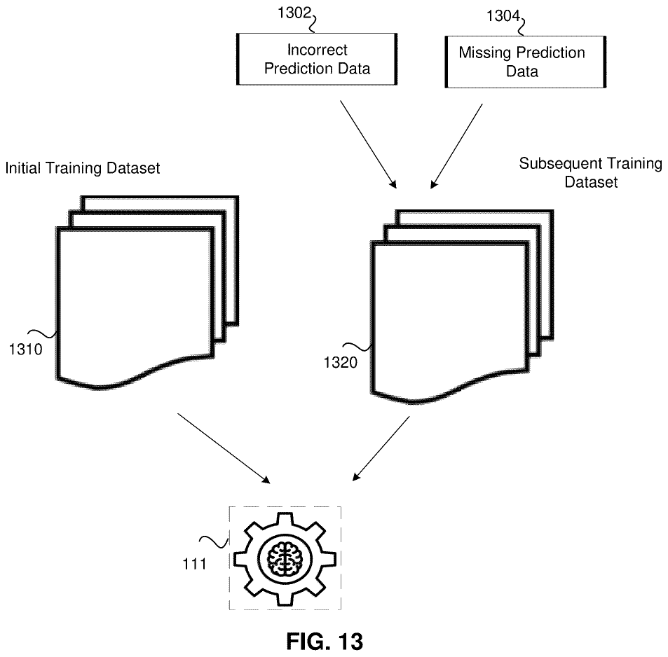

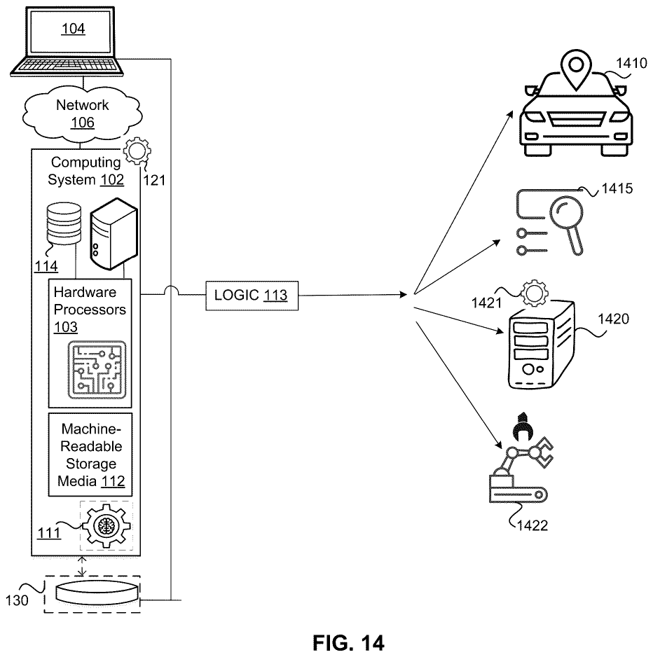

FIG. 13 describes an iterative and/or sequential training process of the machine learning components 111, which may be continuously trained to perform any of the functions described above, including characterizing sensor data, and pattern analysis of characterized sensor data. For example, as new sensor data (e.g., 140), characterized sensor data (e.g., 401, 501, 601-603, 701-702, 801-802, 901-903, 1001-1003, 1101-1102) or feedback and validation data (e.g., 150) is generated or obtained, the machine learning components 111 may be continuously trained. The training may be performed in part by the computing system 102 and/or by a different computing system. For example, the machine learning components 111 may be initially trained using an initial training dataset 1310, and subsequently trained using a subsequent training dataset 1320. The initial training dataset 1310 may include examples of appropriate characterizations of sensor data and/or appropriate patterns. The subsequent training dataset 1320 may include compiled examples, which may encompass, or be generated based on, corrections to incorrect characterizations and/or incorrectly inferred patterns by the machine learning components 111. For example, training using the subsequent training dataset 1320 may occur following a set of inferences which were made at least partially incorrectly by the machine learning components 111. Such incorrect inferences may be attributed to any of incorrect recognition of agents or characteristics within the sensor data, incorrectly weighing of criteria, incorrect correlation identification, and/or incorrect assumptions. The subsequent training dataset 1320 may include and/or be generated based on corrections from example datasets 1302 and 1304. The example datasets 1302 may encompass incorrectly predicted patterns, which may include false positive pattern predictions. For instance, the examples 1302 may include predictions of a relationship between certain characteristics and safety-related parameters that do not exist, or are definitive. Meanwhile, the example datasets 1304 may encompass missing pattern predictions, which may include false negatives. For instance, the examples 1304 may have missed detecting a pattern that actually exists.

In some embodiments, the machine learning components 111 may include an artificial neural network (ANN). The ANN may be programmed on an Application Specific Integrated Circuit (ASIC) or a Field Programmable Gate Array (FPGA). The FPGA may include a plurality of neurons organized in an array. Each neuron may include a register, a microprocessor, and/or at least one input. The ASIC may further include a plurality of synaptic circuit. Each synaptic circuit may include a memory for storing a synaptic weight. Each neuron may be connected to at least one other neuron via one of the plurality of synaptic circuits.

FIG. 14 illustrates downstream actions following the creating or the updating of the ODD. These downstream actions may be part of a workflow or a process. The computing system 102 and/or a different computing system may implement a testing simulation based on the processing of each scenario. The downstream actions may encompass performing navigation 1410, additional monitoring 1415, transmitting and/or writing information to a different computing system 1420, for example, via an API 1421, and/or maintenance or other physical operations 1422 such as adjusting a physical or electronic infrastructure of a vehicle in order to better react to certain safety conditions.

As an example of the additional monitoring 1415, the computing system 102 and/or a different computing system may monitor safety-related parameters such as interaction and speed-related parameters of an ego vehicle, and component parameters such as sensor parameters or tire parameters, to verify whether the safety-related parameters fall within certain operating ranges or thresholds. In some examples, the additional monitoring 1415 may occur in response to certain safety-related parameters falling outside of certain operating ranges or thresholds. An example of transmitting and/or writing information to a different computing system 1420 may include an alert and/or a notification to the computing device 104 and/or to other devices. The alert may indicate which safety-related parameters have fallen outside of operating ranges or thresholds. Alternatively, an alert may be triggered to indicate a predicted time at which a safety-related parameter may fall outside of an operating range or threshold.

In yet other examples, a downstream action may entail an applications programming interface (API) 121 of the computing system 102 interfacing with or calling the API 1421 of the different computing system 1420. For example, the different computing system 1420 may perform analysis and/or transformation or modification of data, through some electronic or physical operation. Meanwhile, the physical operations 1422 may include controlling braking, steering, and/or throttle components to effectuate a throttle response, a braking action, and/or a steering action during navigation, and/or activation of other vehicle components.

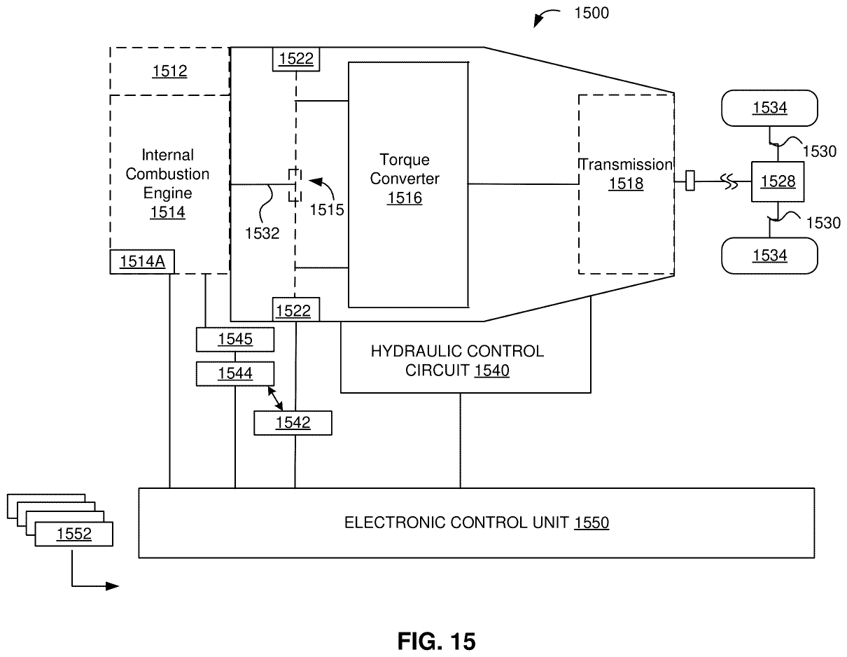

The systems and methods disclosed herein may be implemented with any of a number of different ego vehicles and ego vehicle types. For example, the systems and methods disclosed herein may be used with automobiles, trucks, motorcycles, recreational vehicles and other like on-or off-road vehicles. In addition, the principles disclosed herein may also extend to other vehicle types as well. An example hybrid electric vehicle (HEV) in which embodiments of the disclosed technology may be implemented as an ego vehicle and is illustrated in FIG. 15. Although the example described with reference to FIG. 15 is a hybrid type of ego vehicle, the systems and methods for adaptive and selective extraction of media data can be implemented in other types of ego vehicles including gasoline-or diesel-powered vehicles, fuel-cell vehicles, electric vehicles, or other vehicles.

FIG. 15 illustrates a drive system of an ego vehicle 1500 that may include an internal combustion engine 1514 and one or more electric motors 1522 (which may also serve as generators) as sources of motive power. The ego vehicle 1500 may be implemented as any of the previously described ego vehicles. Driving force generated by the internal combustion engine 1514 and motors 1522 can be transmitted to one or more wheels 1534 via a torque converter 1516, a transmission 1518, a differential gear device 1528, and a pair of axles 1530.

As an HEV, ego vehicle 1500 may be driven/powered with either or both of engine 1514 and the motor(s) 1522 as the drive source for travel. For example, a first travel mode may be an engine-only travel mode that only uses internal combustion engine 1514 as the source of motive power. A second travel mode may be an EV travel mode that only uses the motor(s) 1522 as the source of motive power. A third travel mode may be an HEV travel mode that uses engine 1514 and the motor(s) 1522 as the sources of motive power. In the engine-only and HEV travel modes, ego vehicle 1500 relies on the motive force generated at least by internal combustion engine 1514, and a clutch 1515 may be included to engage engine 1514. In the EV travel mode, ego vehicle 1500 is powered by the motive force generated by motor 1522 while engine 1514 may be stopped and clutch 1515 disengaged.

Engine 1514 can be an internal combustion engine such as a gasoline, diesel or similarly powered engine in which fuel is injected into and combusted in a combustion chamber. A cooling system 1512 can be provided to cool the engine 1514 such as, for example, by removing excess heat from engine 1514. For example, cooling system 1512 can be implemented to include a radiator, a water pump and a series of cooling channels. In operation, the water pump circulates coolant through the engine 1514 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 1514. In other applications, either or both the water pump and the fan may be operated by electric current such as from battery 1544.

An output control circuit 1514A may be provided to control drive (output torque) of engine 1514. Output control circuit 1514A may include a throttle actuator to control an electronic throttle valve that controls fuel injection, an ignition device that controls ignition timing, and the like. Output control circuit 1514A may execute output control of engine 1514 according to a command control signal(s) supplied from an electronic control unit 1550, described below. Such output control can include, for example, throttle control, fuel injection control, and ignition timing control. In some embodiments, the electronic control unit 1550 may be implemented as part of any of the previously described computing systems, such as the computing system 102.

Motor 1522 can also be used to provide motive power in ego vehicle 1500 and is powered electrically via a battery 1544. Battery 1544 may be implemented as one or more batteries or other power storage devices including, for example, lead-acid batteries, nickel-metal hydride batteries, lithium-ion batteries, capacitive storage devices, and so on. Battery 1544 may be charged by a battery charger 1545 that receives energy from internal combustion engine 1514. For example, an alternator or generator may be coupled directly or indirectly to a drive shaft of internal combustion engine 1514 to generate an electrical current as a result of the operation of internal combustion engine 1514. A clutch can be included to engage/disengage the battery charger 1545. Battery 1544 may also be charged by motor 1522 such as, for example, by regenerative braking or by coasting during which time motor 1522 operate as generator.

Motor 1522 can be powered by battery 1544 to generate a motive force to move the vehicle and adjust vehicle speed. Motor 1522 can also function as a generator to generate electrical power such as, for example, when coasting or braking. Battery 1544 may also be used to power other electrical or electronic systems in the vehicle. Motor 1522 may be connected to battery 1544 via an inverter 1542. Battery 1544 can include, for example, one or more batteries, capacitive storage units, or other storage reservoirs suitable for storing electrical energy that can be used to power motor 1522. When battery 1544 is implemented using one or more batteries, the batteries can include, for example, nickel metal hydride batteries, lithium-ion batteries, lead acid batteries, nickel cadmium batteries, lithium ion polymer batteries, and other types of batteries.

An electronic control unit 1550 (described below) may be included and may control the electric drive components of the vehicle as well as other vehicle components. For example, electronic control unit 1550 may control inverter 1542, adjust driving current supplied to motor 1522, and adjust the current received from motor 1522 during regenerative coasting and breaking. As a more particular example, output torque of the motor 1522 can be increased or decreased by electronic control unit 1550 through the inverter 1542.

A torque converter 1516 can be included to control the application of power from engine 1514 and motor 1522 to transmission 1518. Torque converter 1516 can include a viscous fluid coupling that transfers rotational power from the motive power source to the driveshaft via the transmission. Torque converter 1516 can include a conventional torque converter or a lockup torque converter. In other embodiments, a mechanical clutch can be used in place of torque converter 1516.

Clutch 1515 can be included to engage and disengage engine 1514 from the drivetrain of the vehicle. In the illustrated example, a crankshaft 1532, which is an output member of engine 1514, may be selectively coupled to the motor 1522 and torque converter 1516 via clutch 1515. Clutch 1515 can be implemented as, for example, a multiple disc type hydraulic frictional engagement device whose engagement is controlled by an actuator such as a hydraulic actuator. Clutch 1515 may be controlled such that its engagement state is complete engagement, slip engagement, and complete disengagement complete disengagement, depending on the pressure applied to the clutch. For example, a torque capacity of clutch 1515 may be controlled according to the hydraulic pressure supplied from a hydraulic control circuit 1540. When clutch 1515 is engaged, power transmission is provided in the power transmission path between the crankshaft 1532 and torque converter 1516. On the other hand, when clutch 1515 is disengaged, motive power from engine 1514 is not delivered to the torque converter 1516. In a slip engagement state, clutch 1515 is engaged, and motive power is provided to torque converter 1516 according to a torque capacity (transmission torque) of the clutch 1515.

As alluded to above, ego vehicle 1500 may include an electronic control unit 1550. Electronic control unit 1550 may include circuitry to control various aspects of the vehicle operation. Electronic control unit 50 may include, for example, a microcomputer that includes a one or more processing units (e.g., microprocessors), memory storage (e.g., RAM, ROM, etc.), and I/O devices. The processing units of electronic control unit 1550 execute instructions stored in memory to control one or more electrical systems or subsystems in the vehicle. Electronic control unit 1550 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units, or using a single electronic control unit.

In the example illustrated in FIG. 15, electronic control unit 1550 receives information from a plurality of sensors included in ego vehicle 1500. For example, electronic control unit 1550 may receive signals that indicate vehicle operating conditions or characteristics, or signals that can be used to derive vehicle operating conditions or characteristics. These may include, but are not limited to accelerator operation amount, a revolution speed, of internal combustion engine 1514 (engine RPM), a rotational speed of the motor 1522 (motor rotational speed), and vehicle speed. These may also include torque converter 1516 output (e.g., output amps indicative of motor output), brake operation amount/pressure, battery state of charge (SOC) (i.e., the charged amount for battery 1544 detected by an SOC sensor). Accordingly, ego vehicle 1500 can include a plurality of sensors 1552 that can be used to detect various conditions internal or external to the vehicle (e.g., part of the sensor data 140) and provide sensed conditions to engine control unit 1550 (which, again, may be implemented as one or a plurality of individual control circuits). In one embodiment, sensors 1552 may be included to detect one or more conditions directly or indirectly such as, for example, fuel efficiency, motor efficiency, hybrid (internal combustion engine 1514+cooling system 1512) efficiency, acceleration, etc. Electronic control unit 1550 may also receive signals indicative of user behavior. Here, a user may refer to an occupant, such as a driver or a passenger. These signals may include, without limitation, a measure of head or eye movement. In some embodiments, certain user behavior may indicate anomalies in functioning of the ego vehicle 1500, which may trigger an update to the ODD.

In some embodiments, one or more of the sensors 1552 may include their own processing capability to compute the results for additional information that can be provided to electronic control unit 1550. In other embodiments, one or more sensors may be data-gathering-only sensors that provide only raw data to electronic control unit 1550. In further embodiments, hybrid sensors may be included that provide a combination of raw data and processed data to electronic control unit 1550. Sensors 1552 may provide an analog output or a digital output.

Sensors 1552 may be included to detect not only vehicle conditions but also to detect external conditions as well. Sensors that might be used to detect external conditions can include, for example, sonar, radar, lidar or other vehicle proximity sensors, and cameras or other image sensors. Image sensors can be used to detect, for example, traffic signs indicating a current speed limit, road curvature, obstacles, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

The sensors 1552 may be within an interior or on an exterior of the ego vehicle 1550. The sensors 1552 may also include capturing sensors, which capture media data within the ego vehicle 1500 or within surroundings of the ego vehicle 1500. In some embodiments, additional sensors may not be directly connected to the ego vehicle 1500, but rather, may be located on a different entity, such as a drone or a stationary landmark such as a traffic light.

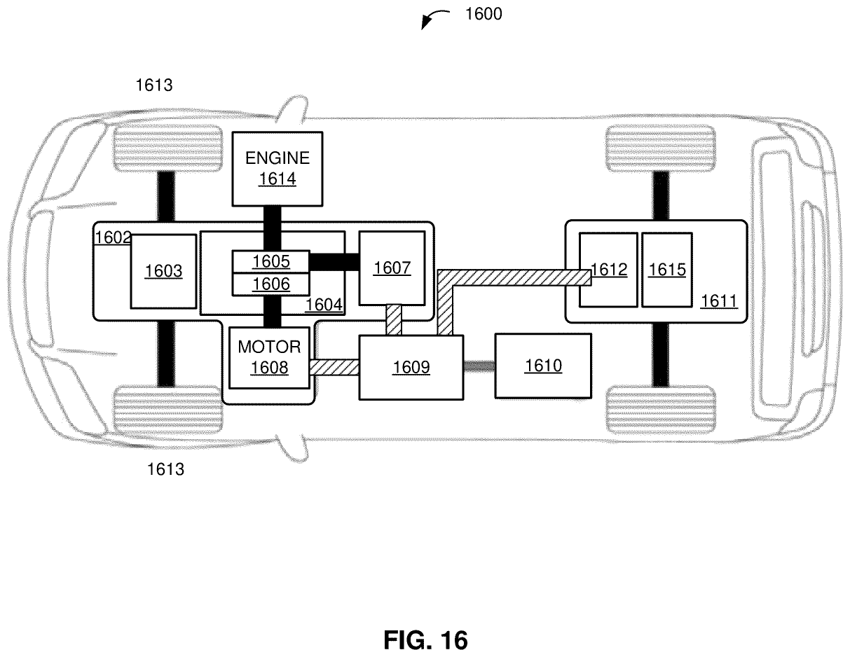

FIG. 16 is another example of an ego vehicle with which systems and methods described above can be implemented. The example illustrated in FIG. 16 is also that of a hybrid vehicle drive system of a vehicle 1600 that may also include an engine 1614 (e.g., internal combustion engine 1614) and one or more electric motors 1608, 1612 as sources of motive power. In this example, a hybrid transaxle assembly 1602 includes front differential 1603, a compound gear unit 1604, a motor 1608, and a generator 1607. Compound gear unit 1604 includes a power split planetary gear unit 1605 and a motor speed reduction planetary gear unit 1606. This example vehicle also includes front and rear drive motors 1608, 1612, an inverter with converter assembly 1609, battery 1610 (which may include multiple batteries), and a rear differential 1615. Hybrid transaxle assembly 1602 enables power from engine 1601, motor 1608, or both to be applied to front wheels 1613 via front differential 1603.

Inverter with converter assembly 1609 inverts DC power from battery 1610 to create AC power to drive AC motors 1608, 1612. In embodiments where motors 1608, 1612 are DC motors, no inverter is required. Inverter with converter assembly 1609 also accepts power from generator 1607 (e.g., during engine charging) and uses this power to charge battery 1610.

The examples of FIGS. 15 and 16 are provided for illustration purposes only as examples of vehicle systems with which embodiments of the disclosed technology may be implemented. One of ordinary skill in the art reading this description will understand how the disclosed embodiments can be implemented with vehicle platforms.

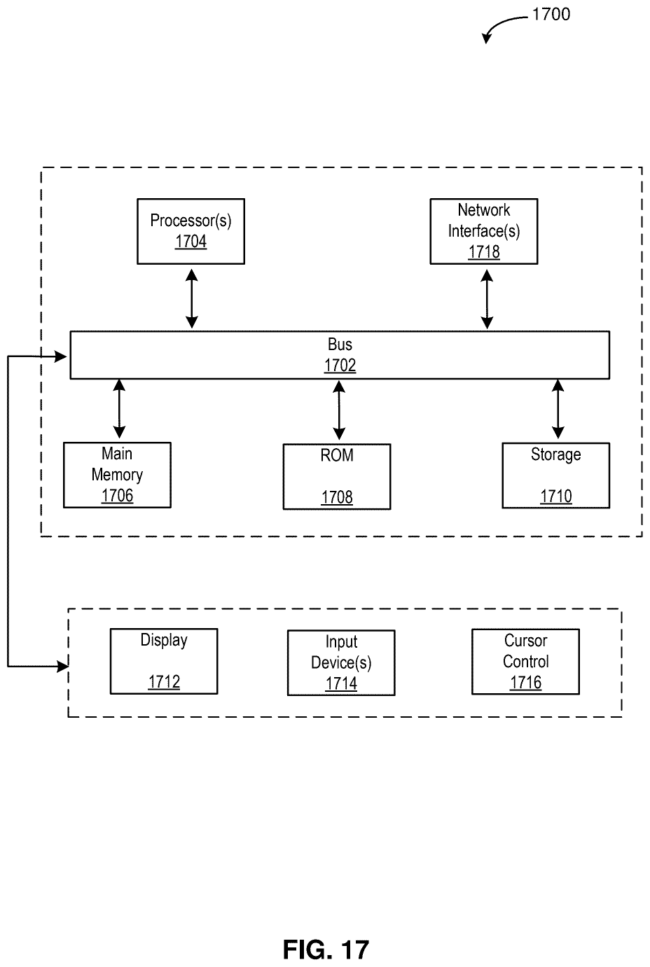

FIG. 17 illustrates a block diagram of a computer system 1700 upon which any of the embodiments described herein may be implemented. The computer system 1700 includes a bus 1702 or other communication mechanism for communicating information, one or more hardware or other processors, such as cloud processors, 1704 coupled with bus 1702 for processing information. A description that a device performs a task is intended to mean that one or more of the processor(s) 1704 performs.

The computer system 1700 also includes a main memory 1706, such as a random access memory (RAM), cache and/or other dynamic storage devices, coupled to bus 1702 for storing information and instructions to be executed by processor 1704. Main memory 1706 also may be used for storing temporary variables or other intermediate information during execution of instructions to be executed by processor 1704. Such instructions, when stored in storage media accessible to processor 1704, render computer system 1700 into a special-purpose machine that is customized to perform the operations specified in the instructions.

The computer system 1700 further includes a read only memory (ROM) 1708 or other static storage device coupled to bus 1702 for storing static information and instructions for processor 1704. A storage device 1710, such as a magnetic disk, optical disk, or USB thumb drive (Flash drive), etc., is provided and coupled to bus 1702 for storing information and instructions.

The computer system 1700 may be coupled via bus 1702 to output device(s) 1712, such as a cathode ray tube (CRT) or LCD display (or touch screen), for displaying information to a computer user. Input device(s) 1714, including alphanumeric and other keys, are coupled to bus 1702 for communicating information and command selections to processor 1704. Another type of user input device is cursor control 1716. The computer system 1700 also includes a communication interface 1718 coupled to bus 1702.

Unless the context requires otherwise, throughout the present specification and claims, the word “comprise” and variations thereof, such as, “comprises” and “comprising” are to be construed in an open, inclusive sense, that is as “including, but not limited to.” Recitation of numeric ranges of values throughout the specification is intended to serve as a shorthand notation of referring individually to each separate value falling within the range inclusive of the values defining the range, and each separate value is incorporated in the specification as it were individually recited herein. Additionally, the singular forms “a,” “an” and “the” include plural referents unless the context clearly dictates otherwise. The phrases “at least one of,” “at least one selected from the group of,” or “at least one selected from the group consisting of,” and the like are to be interpreted in the disjunctive (e.g., not to be interpreted as at least one of A and at least one of B).

Reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment, but may be in some instances. Furthermore, the particular features, structures, or characteristics may be combined in any suitable manner in one or more embodiment.

A component being implemented as another component may be construed as the component being operated in a same or similar manner as the another component, and/or comprising same or similar features as the another component.

1. A system comprising:
one or more processors; and
a memory storing instructions that, when executed by the one or more processors, cause the system to perform:
obtaining sensor data;
characterizing the sensor data;
obtaining one or more analysis results from the characterized sensor data;
validating the one or more analysis results based on feedback data;
based on the one or more analysis results and the validation thereof, creating an operational design domain, wherein the operational design domain comprises a dataset specifying operational extents of an ego vehicle corresponding to different constraints; and
generating an operational protocol based on the operational design domain, wherein the generating of the operational protocol comprises translating the operational design domain into executable commands directed to the ego vehicle.

2. The system of claim 1, wherein the obtaining of the sensor data is from different sensor modalities, the different sensor modalities comprising a Lidar, a camera, and a radar.

3. The system of claim 1, wherein the characterizing of the sensor data comprises fusing the obtained sensor data into a unified data collection, wherein the fusing of the obtained sensor data comprises normalizing different formats of the sensor data into a common format.

4. The system of claim 1, wherein the obtaining of the one or more analysis results is based on classical pattern recognition techniques and machine learning techniques; and the obtaining of the one or more analysis results comprises:
identifying characteristics, from the characterized sensor data, that have an impact on one or more safety-related parameters; and
inferring, from the characterized sensor data, a degree of impact of each characteristic on the one or more safety-related parameters.

5. The system of claim 1, wherein the operational extents indicate permitted actions and restrictions of the ego vehicle.

6. The system of claim 1, wherein the constraints comprise geographical conditions, traffic conditions, environmental conditions, temporal conditions, or infrastructure conditions.

7. The system of claim 1, wherein the instructions further cause the system to perform:
implementing the executable commands within components of the ego vehicle, the components comprising an actuator, brake, and/or steering wheel.

8. The system of claim 1, wherein the implementing of the executable commands comprises selectively limiting a force applied to the actuator or selectively limiting an amount of turning of the steering wheel.

9. The system of claim 1, wherein the instructions further cause the system to perform:
based on the feedback data, training a machine learning component that performs part of the obtaining of the one or more analysis results.

10. The system of claim 1, wherein the instructions further cause the system to perform:
in response to generating the operational protocol, monitoring one or more ego vehicle safety-related parameters when the ego vehicle is operating according to the operational protocol; and
in response to detecting that one or more ego vehicle safety-related parameters fall outside of respective safety ranges, iteratively updating the operational design domain until the one or more ego vehicle safety-related parameters are within the respective safety ranges.

11. A method implemented by one or more processors of a computing system, the method comprising:
obtaining sensor data;
characterizing the sensor data;
obtaining one or more analysis results from the characterized sensor data;
validating the one or more analysis results based on feedback data;
based on the one or more analysis results and the validation thereof, creating an operational design domain, wherein the operational design domain comprises a dataset specifying operational extents of an ego vehicle corresponding to different constraints; and
generating an operational protocol based on the operational design domain, wherein the generating of the operational protocol comprises translating the operational design domain into executable commands directed to the ego vehicle.

12. The method of claim 11, wherein the obtaining of the sensor data is from different sensor modalities, the different sensor modalities comprising a Lidar, a camera, and a radar.

13. The method of claim 11, wherein the characterizing of the sensor data comprises fusing the obtained sensor data into a unified data collection, wherein the fusing of the obtained sensor data comprises normalizing different formats of the sensor data into a common format.

14. The method of claim 11, wherein the obtaining of the one or more analysis results is based on classical pattern recognition techniques and machine learning techniques; and the obtaining of the one or more analysis results comprises:
identifying characteristics, from the characterized sensor data, that have an impact on one or more safety-related parameters; and
inferring, from the characterized sensor data, a degree of impact of each characteristic on the one or more safety-related parameters.

15. The method of claim 11, wherein the operational extents indicate permitted actions and restrictions of the ego vehicle.

16. The method of claim 11, wherein the constraints comprise geographical conditions, traffic conditions, environmental conditions, temporal conditions, or infrastructure conditions.

17. The method of claim 11, further comprising:
implementing the executable commands within components of the ego vehicle, the components comprising an actuator, brake, and/or steering wheel.

18. The method of claim 11, wherein the implementing of the executable commands comprises selectively limiting a force applied to the actuator or selectively limiting an amount of turning of the steering wheel.

19. The method of claim 11, further comprising:
based on the feedback data, training a machine learning component that performs part of the obtaining of the one or more analysis results.

20. The method of claim 11, further comprising:
in response to generating the operational protocol, monitoring one or more ego vehicle safety-related parameters when the ego vehicle is operating according to the operational protocol; and
in response to detecting that one or more ego vehicle safety-related parameters fall outside of respective safety ranges, iteratively updating the operational design domain until the one or more ego vehicle safety-related parameters are within the respective safety ranges.
